(19) United States
(12) Patent Application Publication
(10) Pub. No.: US 2026/0240167 A1
(43) Pub. Date: Aug. 20, 2026

(54) ANTIMICROBIAL ARTICLES WITH A SURFACE CONTAINING COPPER, SILVER, AND/OR GOLD NANOSTRUCTURES, AND METHODS OF MAKING

(71) Applicants: CORNING INCORPORATED, CORNING, NY (US); THE INSTITUTE OF PHOTONIC SCIENCES, Castelldefels (ES); INSTITUCIÓ CATALANA DE RECERCA I ESTUDIS AVANÇATS (ICREA), Barcelona (ES)

(72) Inventors: Christina Louise Graham, Barcelona (ES); Valerio Pruneri, Castelldefels (ES); Wageesha Senaratne, Horseheads, NY (US); Dean Michael Thelen, Addison, NY (US)

(21) Appl. No.: 19/159,518

(22) PCT Filed: Feb. 22, 2024
(86) PCT No.: PCT/US2024/016807

§ 371 Date: Aug. 25, 2025

Related U.S. Application Data
(60) Provisional application No. 63/448,901, filed on Feb. 28, 2023.
(60) Provisional application No. 63/609,463, filed on Dec. 13, 2023.

(51) Int. Cl. A01N 59/20; A01N 25/08; A01N 25/24; A01N 59/00; A01N 59/16

(52) U.S. Cl. CPC A01N 59/20; A01N 25/08; A01N 25/24; A01N 59/00; A01N 59/16

(57) ABSTRACT

An antimicrobial article and methods of making, the antimicrobial article comprising a substrate comprising a first major surface and a second major surface; an optional adhesion layer disposed on the first major surface of the substrate; discontinuous islands comprising copper, silver, gold, or any combination thereof disposed on the first major surface of the substrate, the optional adhesion layer if present, or both; and a dielectric layer disposed between and at least partially covering the discontinuous islands; wherein the discontinuous islands and the dielectric layer together form an outer antimicrobial surface.

This application claims the benefit of priority of U.S. Provisional Application 63/609,463, filed on Dec. 13, 2023, and U.S. Provisional Application 63/448,901, filed on Feb. 28, 2023, the content of each of which is relied upon and incorporated herein by reference in its entirety.

### FIELD

The disclosure relates generally to antimicrobial articles with a surface containing metal nanostructures, and more particularly to antimicrobial articles comprising glass with a surface containing discontinuous islands comprising copper, silver, gold, or any combination thereof.

### BACKGROUND

Touch-activated surfaces are ubiquitous in contemporary society, and such surfaces have the potential to harbor infectious pathogens, including bacteria and viruses. As a result, there is a need for surfaces having antimicrobial properties.

### SUMMARY

The disclosure relates, in various aspects, to an antimicrobial article, comprising:
a substrate comprising a first major surface and a second major surface;
an optional adhesion layer disposed on the first major surface of the substrate;
discontinuous islands comprising copper, silver, gold, or any combination thereof disposed on the first major surface of the substrate, the optional adhesion layer if present, or both; and
a dielectric layer disposed between and at least partially covering the discontinuous islands;
wherein the discontinuous islands and the dielectric layer together form an outer antimicrobial surface.

In some aspects, the antimicrobial articles exhibit one or more of an average light transmission of at least 60% of incident light in a range of 380-750 nm; a difference between minimum light transmission and maximum light transmission of 20% or less; a transmission haze of 5% or less; a greater than 3 logarithmic reduction in a concentration of Staphylococcus aureus as measured according to U.S. Environmental Protection Agency (EPA) 2008 Test Method for Efficacy of Cu Alloy Surfaces as a Sanitizer; a water contact angle of at least 80 degrees; and/or after a durability test is within 20% of the original value of one of more of any of the foregoing properties.

In some aspects, disclosed is a method for making an antimicrobial article, the method comprising:
providing a substrate comprising a first major surface and a second major surface;
optionally positioning an adhesion layer on the first major surface;
depositing a layer comprising copper, silver, gold, or any combination thereof on the first major surface of the substrate, the adhesion layer if present, or both;
thermally treating the layer to form discontinuous islands comprising copper, silver, gold, or any combination thereof; and
disposing a dielectric layer between and at least partially covering the discontinuous islands;
wherein the discontinuous islands and the dielectric layer together form an outer antimicrobial surface.

In some aspects, disclosed is a method for making the antimicrobial articles, the method comprising:
providing the substrate comprising the first major surface and the second major surface;
optionally positioning the adhesion layer on the first major surface;
depositing discontinuous islands comprising copper, silver, gold, or any combination thereof on the first major surface of the substrate, the optional adhesion layer if present, or both by way of a Langmuir-Blodgett technique; and
disposing the dielectric layer between and at least partially covering the discontinuous islands;
wherein the discontinuous islands and the dielectric layer together form an outer antimicrobial surface.

Additional features and advantages of the disclosure will be set forth in the detailed description which follows, and in part will be readily apparent to those skilled in the art from that description or recognized by practicing the aspects as described herein, including the detailed description which follows, the claims, as well as the appended drawings.

It is to be understood that both the foregoing general description and the following detailed description are merely exemplary and are intended to provide an overview or framework for understanding the nature and character of the disclosure and claims. The accompanying drawings are included to provide a further understanding of the disclosure and are incorporated into and constitute a part of this specification. The drawings illustrate various aspects of the disclosure and together with the description serve to explain the principles and operations of the various aspects.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 is a schematic illustration of a cross section of an antimicrobial article.

FIG. 2 is a scanning electron microscopy (SEM) image of a surface comprising discontinuous islands comprising copper(0), copper(I), or both. The parameters of the scan are as follows. HV 5.00 kV; det ETD; magnification 160,000×; WD 9.9 mm; spot 3.0; tilt −14°. The scale bar is 500 nm.

FIG. 3 is a graph illustrating the light transmission of various samples at two different thicknesses of copper film that have been dewetted at the same conditions indicated in the figure.

FIG. 4 is a graph with two inset photographs. FIG. 4 illustrates a comparison of the light transmission of a representative sample of 3.5 nm copper film on a glass substrate that has been dewetted at 390° C. (dotted line; right photograph) and 750° C. (solid line; left photograph) to form discontinuous islands of copper. Both samples also have an additional 25 nm SiO₂ capping layer deposited between and at least partially covering the discontinuous islands. The color of the left photograph corresponds to an RGB color code of approximately 151, 157, 145, whereas the right photograph has a color that corresponds to an RGB color code of approximately 205, 200, 180. The sample dewetted at higher temperature (left photograph) shows stronger coloring that has a pink hue.

FIG. 5 is a schematic representation of a method for making discontinuous islands comprising copper, silver, gold, or any combination thereof.

FIG. 6 includes two graphs and two schematic representations. The two graphs illustrate the alternating-current impedance ratio of an antimicrobial article in accordance with one aspect relative to an otherwise identical article that does not have the discontinuous islands. The results are for a Finite Element Model Predictions for two dewetting cases, namely, copper film and dewetting conditions that result in 164 nm spacing and 84 nm gap for Case 1 and 164 nm spacing and 48 nm gap for Case 2. These lateral-surface impedance predictions demonstrate that capacitive touch performance can coexist with this dewetting process.

FIG. 7 includes scanning electron microscopy (SEM) images and several graphs with inset images. The SEMs show the difference in structure of the discontinuous islands depending on dewetting conditions. The graphs depict experimental and simulated light transmission of such structures. The scale bars in the SEM images is 100 nm.

FIG. 8 includes two graphs illustrating log reduction (LR) and copper concentration leached as a function of dielectric layer (silica) thickness and easy-to-clean (ETC) coating (e.g., hydrophobic and/or oleophobic) for both 50 W and 300 W oxygen plasma treated copper discontinuous islands.

FIG. 9 includes several graphs with inset photographs, which graphs show several properties of antimicrobial articles that have been subjected to durability tests with various kinds of wipes, both wet and dry.

FIG. 10 includes two graphs illustrating the amount of copper dissolved into the liquid of a mock test as a function of log reduction in S. Aureus, as well as the light transmission over a wavelength range for samples both pre and post mock test.

### DETAILED DESCRIPTION

As used herein, the term “surface-lateral electrical impedance ratio” means the ratio of the measured electrical impedance value of an antimicrobial article (as described elsewhere herein) relative to the measured electrical impedance value of an otherwise identical reference substrate (e.g., bare glass). For example, when the article is an antimicrobial article (as described elsewhere herein), e.g., comprising a substrate comprising glass, an optional adhesion layer, discontinuous islands comprising copper, silver, gold, or any combination thereof, and a dielectric layer disposed between and at least partially covering the discontinuous islands, then the surface-lateral electrical impedance ratio is the measured electrical impedance value of this antimicrobial article relative to the measured electrical impedance value of an otherwise identical reference substrate comprising glass, i.e., which does not include an optional adhesion layer, discontinuous islands comprising copper, silver, gold, or any combination thereof, and a dielectric layer disposed between and at least partially covering the discontinuous islands. For clarity, the substrates of the antimicrobial article and the reference substrate have the same composition, dimensions, fabrication process, and so forth.

As used herein, the term “transmission,” “optical transmission,” “light transmission,” and similar terms are used interchangeably herein to mean the amount of light at a given wavelength or wavelength range that passes through a given object relative to the amount of incident light at the same wavelength or wavelength range. Transmission (T) is calculated according to the following equation: % T=(I/Iₒ)*100, in which I is transmitted light intensity at a given wavelength or wavelength range, and Iₒ is incident light intensity at a given wavelength or wavelength range. In some aspects, the transmission is averaged over the wavelength range of 380-750 nm, or at a specific wavelength in such range, as can be made clear from context. As used herein, transmission refers to the transmission measured through a substrate, adhesion layer if present, discontinuous islands, dielectric layer, and hydrophobic and/or oleophobic coating if present. In this regard, transmission does not include transmission through other materials if present, such as mobile device housing or electronic components, for example.

As used herein, the term “transmission haze” or “haze” are used interchangeably herein to mean the percent of transmitted light that is scattered so that its direction deviates more than +2.5 degrees from the direction of the incident beam. As used herein, transmission haze refers to the haze as measured through a substrate, adhesion layer if present, discontinuous islands, dielectric layer, and hydrophobic and/or oleophobic coating if present. In this regard, transmission haze does not include measurement through other materials if present, such as mobile device housing or electronic components, for example.

As used herein, the term “longest lateral dimension” refers to a particular dimension of an item or object that is parallel to the surface of the substrate. Thus, to clarify, when an object is circular, the longest lateral dimension is its diameter; when an object is oval-shaped, the longest lateral cross-sectional dimension is the longest diameter of the oval; and when an object is irregularly-shaped, the longest lateral cross-sectional dimension is the line between the two farthest opposing points on the perimeter of the object. The average of the longest lateral dimension is calculated by measuring a representative number of discontinuous islands and averaging the result on a numbers basis. “Average height” is also calculated by measuring a representative number of discontinuous islands and averaging the result on a numbers basis.

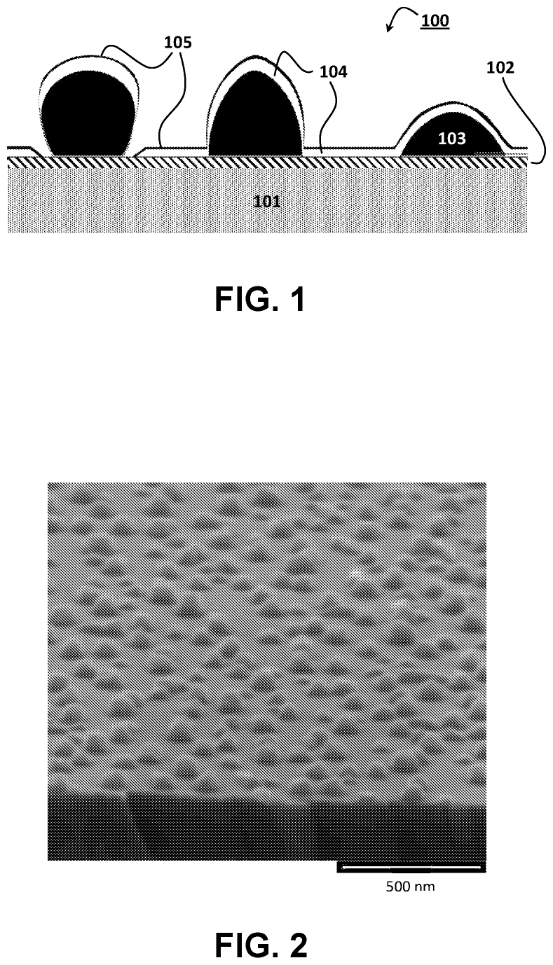

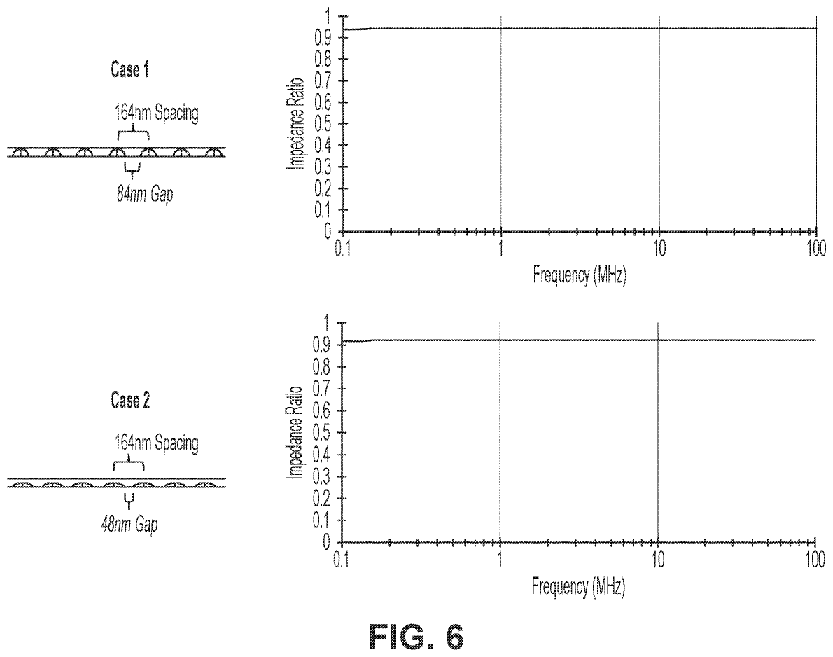

When discontinuous islands are disclosed to be “measured from the first major surface or the optional adhesion layer if present” this terminology generally means that the height or coverage of a dielectric layer (or similar references herein) of the islands is measured by reference to what they are disposed on top of. In some aspects, the islands are disposed on the substrate itself, and in other aspects the islands are disposed on top of an adhesion layer. In this way, it is the height of the islands themselves that is of interest and is referenced. In this regard, the average height can be understood by reference to FIG. 1. The average height would be measured from the bottom of the islands where they abut the adhesion layer to the apex of the particles. Similarly, the phrase “the bases are where the discontinuous islands abut the first major surface or the optional adhesion layer if present” is in reference to what the islands are disposed on (the substrate itself or an adhesion layer). In this regard, the average distance between bases can be viewed by reference to FIG. 1, in which the average distance for two islands is the shortest distance between the bases (e.g., for the middle island and the island on the right, it is the distance between (1) the right-most portion of the middle island at the point where the island abuts the adhesion layer and (2) the left-most portion of the right island at the point where the island abuts the adhesion layer. This concept is also shown schematically in FIG. 6 by the features “84 mm Gap” and “48 mm Gap.” In this regard, the average distance between adjacent bases of the discontinuous islands is not the spacing from center to center of two adjacent islands.

In some aspects, disclosed are antimicrobial articles and methods of making and using. In some aspects, the antimicrobial articles are durable, optically transparent, or both. In some aspects, the antimicrobial articles comprise glass. In some aspects, disclosed is an antimicrobial article comprising a glass substrate, in which the antimicrobial article has antimicrobial properties conferred by a nanostructured surface comprising copper, silver, gold, or any combination thereof. In some aspects, the nanostructured surface is transparent in the visible region, clear, and will not substantially change the original properties of the substrate (e.g., touch capacitance). In some aspects, the nanostructured surface is capable of substantially retaining optical properties of the receiving substrate (e.g., a substrate comprising glass), such as haze, neutral color, and visible light transmission, and confer antimicrobial (AM) properties after repeated contact with external objects such as, for example, when wiping with a towel or cloth, and/or touching with human fingers.

In the last decades, there has been a huge uptake in the incorporation of touch-activated glass-based surfaces in contemporary society. The COVID19 pandemic highlighted the potential of surfaces to harbour harmful microorganisms by contamination with infectious droplets from sneezing, coughing, speaking and breathing. Now more than ever, the importance of effective disinfection practices for surfaces with constant and repeated use has become a priority. In the first instance, surface contamination is combatted by spraying the surface with an alcohol-based disinfectant, soap or antimicrobial wipes. While effective in the short-term, these procedures are impractical for multi-user surfaces and require continuous re-application to clear any microbes present on the surface.

Accordingly, a need exists for functional surfaces that are persistently antimicrobial, resistant to general use wear-and-tear and sufficiently transparent to retain their functionality. Transparency typically includes high light transmission combined with low scattering (haze). In addition, it is desirable that the functional surfaces maintain the neutral color of the original substrate as much as possible, i.e. that generally means that their transmission is independent of wavelength. In addition, the electrically insulating function of these touch-activated devices must be maintained.

There are currently two primary approaches to engineer antimicrobial functionality into glass. The first is to modify the glass itself by imparting an antimicrobial agent for example copper, silver, and/or gold ions directly into the glass surface by an ion-exchange process.

The second approach is to create a coating on the surface of the glass. The first is that of incorporating photocatalytically active materials such as titanium dioxide (TiO₂) or zinc oxide (ZnO) into surface coatings. These materials interact with moisture and light to produce bactericidal reactive oxygen ion species on the surface coating. While effective in certain circumstances, these coatings are light activated and are not suitable for touch surfaces in indoor environments or outdoor environments with low natural light conditions.

In some aspects, for certain applications (e.g., touch surfaces) intended for the antimicrobial articles disclosed herein, it is beneficial that the surfaces are durable and retain their antimicrobial property, even after repeated and extended use. Generally, surfaces having nanostructures often lack durability due to the removal of the nanostructures by repeated use (e.g., friction), such as by wiping with a cleaning cloth, frequent contact with a pants pocket or purse during removal and insertion, touching with a human finger, and/or chemical interaction with the environment or cleaning solutions. It is also advantageous for antimicrobial articles having high antimicrobial activity while remaining optically transparent, electrically insulating, and/or durable. In some aspects, the antimicrobial articles disclosed herein have one or more of such properties. In some aspects, the antimicrobial articles disclosed herein can be produced with a scalable method to achieve a colorless or nearly colorless nanostructured copper based surface on a substrate, such as glass, which surface is >99.9% effective against bacteria using the EPA dry test requirement, as described elsewhere herein.

In some aspects, disclosed is a method of creating transparent copper, silver, and/or gold based nanostructured antimicrobial coatings on glass substrates. In some aspects, the antimicrobial agent is copper, silver, gold, or any combination thereof, which antimicrobial agent is obtained on the glass surface in the form of discontinuous islands, sometimes called dewetted discontinuous islands. In some aspects, these structures have limited plasmonic response, making the surface mostly colorless. In some aspects, one or more dielectric layers (e.g., an inorganic oxide such as SiO₂) may be deposited on top of the discontinuous islands to secure the dewetted particles to the surface and enhance their durability against the environment, external chemical agents, and mechanical forces. In such a way, an antimicrobial surface can be created, and by tuning the thickness of the dielectric layer, it is possible to tune the release of the copper. As used herein, the term “dewetting” generally means a thermal treatment step, as described elsewhere herein.

In some aspects, disclosed are antimicrobial articles having a durable coating comprising discontinuous islands that exhibit an antimicrobial function. Referring to FIG. 1, in some aspects, the antimicrobial articles comprise: a substrate 101 (e.g., transparent substrate optionally comprising glass) upon which an optional adhesion layer 102 (e.g., ultrathin continuous function layer, such as an adhesion layer, dewetting promotor, or Langmuir-Blodgett deposition promotor) is deposited; a second layer comprising discontinuous islands 103 obtained in some aspects through metal dewetting and with an average particle size and distribution to obtain, in some aspects, high optical transmission, limited haze, and limited color; and a dielectric layer 104 (e.g., inorganic oxide or other material) to embed and secure the discontinuous islands to the surface, and also helps, in some aspects, to tune copper, silver, and/or gold release rate. In some aspects, the dielectric layer 104 is deposited conformally on top of the discontinuous islands to embed and secure them to the surface. In some aspects, this dielectric layer 104 has a height that is within approximately 50%, (e.g., within 60%, within 70%, within 80%, within 90%, within 100%, or more than 100%) of the average particle height of the discontinuous islands comprising copper, silver, gold, or any combination thereof. In some aspects, a hydrophobic and/or oleophobic coating 105 is deposited on top of the dielectric layer-embedded discontinuous islands of copper, silver, and/or gold. In some aspects, such hydrophobic and/or oleophobic properties enhance the ‘cleanability’ of the antimicrobial article, repelling dirt and preventing smudging from fingerprints, and can also serve to tune the ion release rate of copper, silver, gold, or any combination thereof.

As used herein, a “durability test” also called a “wipe test” is a test performed on the antimicrobial articles disclosed herein to assess their durability in terms of retention of various properties, including transmission, haze, water contact angle, and antimicrobial efficacy per the EPA Test. The durability test generally includes employing wet wipe cycles or dry wipe cycles, where wipe cycles generally are 100 wipe cycles or more (e.g., 100 cycles, 330 cycles, 730 cycles, and so forth) with either a dry cloth, or with a wet cloth impregnated with a isopropanol (IPA) and deionised water mixture in a ratio 70:30 vol. %, deionized water alone, or a liquid based sanitizer solution (e.g. LYSOL™, CLOROX™). A “wipe cycle” means two strokes (i.e., one back and forth cycle). A force of 9 N was applied on the cloth using a crockmeter over an area of 2 cm². Generally, in the durability test AM articles were subjected to standardized dry and wet abrasion procedures, simulating regular touch and a worst-case scenario of 2× cleaning every day for up to 2 years. Simulated wear was performed using an Elcometer 5750 TABER™ Linear Abraser. A cloth was saturated with a liquid (e.g., cleaning solution) and attached to the abrader head using double-sided adhesive tape. No additional accessory weights were added to the spline-shaft of the linear abrader (base load of 350 g) in order to keep the pressure similar to that applied in by repeated touch or cloth wipes. This process was repeated for a certain number of cycles, such as 700-1200 cycles (1400-2400 passes of the wet or dry cloth), to simulate wear and cleaning for up to 2 years. After completion of the wear cycles, the ‘worn’ surfaces were tested for bacterial efficacy against S. Aureus using the EPA Test, as well as other optical and water contact angle properties. The “cloth” used in the durability tests is made of a standard material that is typically marketed and sold for use with electronic device touch screens (e.g., BIOPURE™ 70% IPA wipes, or “Just Add Water” personal electronics cloths available from E-CLOTH™), and thus does not readily impart scratches or damage to such a touchscreen surface. Such standard materials can include 100% natural fibers such as cellulose (e.g., paper cloths), artificial fibers such as polyethylene and/or polypropylene, or mixtures of natural fibers and artificial fibers. The “cloths” can also be the typical disinfecting wipes sold by LYSOL™ and CLOROX™, which are not typically marketed for touchscreen devices but can be used on them without readily imparting scratches or damage. The “cloths” used herein are not intended to include materials such as scouring pads or steel wool, which typically are made of abrasive and tough materials so as to aggressively mechanically abrade material from a surface (and would damage the surface of a touchscreen device). Further information on typical setup conditions for the durability test are as follows. Sample size 50×50 mm; weight 680 g; stroke length 18 mm; collet 1 inch diameter; speed 40 CPM. In a wet test, four wipes were staked so as to maintained moisture due to capillary action; however, if wetness dissipated throughout a long (many cycle) test, then the used wipes were replaced with new wipes. If desired, for a single durability test that spans several days, the old wipes can be replaced with new wipes every day. It is not believed that the results are affected by using old or new wipes, provided that the moisture condition is maintained (e.g., dry conditions in a dry test and liquid conditions in a liquid test).

Regarding the durability test, some properties are described herein to be within a certain percentage (e.g., 20%) of their original value after the durability test. As used herein, this means that if the original value is 85% and after the durability test the value is now 66%, such value would not be within 20% of the original value (e.g., 85-(85*0.2)=68 as a minimum value to meet the “within 20% requirement). This concept is to be distinguished from the feature herein “the antimicrobial article exhibits a difference between minimum light transmission and maximum light transmission of 20% or less” since this term relates to a difference (i.e. maximum minus minimum) rather than a percentage of original value.

In some aspects, after the durability test (wipe test), the variation in the transmission haze relative to initial value (i.e., prior to the durability test) is less than 20%, e.g., less than 15%, less than 10%, or less than 5%. In some aspects, an outer surface of an antimicrobial article possesses at least 99.9% (Log 3) kill, also referred to herein as log 3 reduction or log 3 kill, measured according to the EPA dry test against bacteria or viruses (United States Environmental Protection Agency—Test Method for Efficacy of Copper Alloy Surfaces as a Sanitizer (United States Environmental Protection Agency, Washington DC, 2008), incorporated by reference herein in its entirety) (“EPA Test”) and maintained at least a log 3 kill after the durability test.

Briefly, the “EPA Test” generally was performed as follows. Coupons were prepared, including those containing an antimicrobial surface as disclosed herein, as well as control surfaces such as copper, stainless steel, and uncoated glass. Each coupon was tested in duplicate. Prior to antimicrobial (AM) efficacy testing, all coupons were cleaned by immersion in a 75% ethanol solution followed by rinsing with deionized (DI) water. The coupons were then sterilized by exposure to UV light at 254 nm, for a duration of 15 minutes. For the preparation of the inoculum, a 20 μL aliquot of thawed bacterial Staphylococcus aureus AT 6538 (S. Aureus) culture was added to 10 mL Tryptic Soy Broth. The bacterial suspension was incubated at 36° C. for 48 h. The culture was subsequently centrifuged and allowed to settle. The supernatant was removed and the pellet was resuspended in 6 mL of phosphate buffer saline (PBS). The upper two thirds of suspension were aspirated and the optical density at 600 nm (OD600) was measured to obtain an estimation of bacterial density. The cell culture was diluted with PBS to achieve a bacterial inoculum concentration near the target value of 1.0×10⁶ colony-forming units (CFU) mL⁻¹. Organic soil load containing 250 L fetal bovine serum (FBS) and 50 μL TRITON™ X was added to 4700 μL of the inoculum to aid in spreading. Each coupon was inoculated with 20 μL of inoculum. The inoculum volume was spread evenly over a central 2.5 cm² test area of the coupon using bent sterile pipette tips. The coupons were dried for 20-40 mins in ambient conditions. Once dry the coupons were incubated in a controlled environment set at 42% relative humidity (RH) and 23° C. for a period of 2 hours. Following the 2-hour exposure period, the coupons were neutralized in Letheen broth. Ten-fold serial dilutions of the neutralized solutions were plated using standard spread plate technique on Tryptic Soy Agar plates and incubated for 48 h at 36° C. to yield countable numbers of survivors (approximately 20-200 colonies per plate). This range was selected because below 20 CFUs gives poor counting statistics and above 200 CFUs the bacteria grow too close together. The number of surviving CFUs per carrier (CFU/carrier) was determined by the following equation:

(average number CFUs/plate@dilution)·(dilution factor)·(volume neutralized solution)/volume plated

The calculation of the value of the antimicrobial activity is based on the log₁₀ difference between the mean number of bacteria surviving on the antimicrobial surface and the mean number of bacteria surviving on the SS control samples. The mean log reduction (LR) was calculated as the average antilog of duplicate tests: (−Log₁₀ X1+−log₁₀ X2)/2, where ‘X’ represents the number of CFU/carrier on the antimicrobial surface or control sample. The percentage (%) reduction was calculated as =(1−10-^{LR})×100. For the coatings to be approved as a ‘self-sanitising,’ the AM test should be at least a 3 log reduction within the specified contact time. This corresponds to a 99.99% reduction in CFUs.

In some aspects, the antimicrobial articles disclosed herein comprise copper-, silver-, and/or gold-containing discontinuous islands secured to a substrate (e.g., a glass article) in such a way that the antimicrobial surface thereof is extremely durable, and the antimicrobial article has an average optical transparency between 65-90% in the region 380-750 nm, and an antimicrobial efficacy of 99.9% (i.e., at least log 3 reduction). In some aspects, the resulting antimicrobial articles are extremely durable owing, in some aspects, to a dielectric layer (e.g., SiO₂) that embeds the discontinuous islands and secures them to the surface. In some aspects, a hydrophobic and/or oleophobic coating deposited over the dielectric layer and discontinuous islands renders the antimicrobial articles easy to clean. In some aspects, the antimicrobial articles comprising such an antimicrobial surface may be useful in applications of technological interest such as modern touchscreen devices like phones, public display touchscreens, automated teller machines (ATMs), and other such applications. In some aspects, the discontinuous islands are formed by dewetting (e.g., heat treating or annealing) a copper, silver, and/or gold film that has been deposited on a substrate. In some aspects, the discontinuous islands are formed by other techniques, such as the Langmuir-Blodgett technique. In any case, a dielectric layer can be deposited over the discontinuous islands comprising copper (e.g., Cu and/or Cu₂O particles), silver, gold, or any combination thereof to secure and embed such discontinuous islands to the surface of the antimicrobial article.

In some aspects, advantages of the antimicrobial articles disclosed herein include optical transparency, durability, and retention of antimicrobial efficacy, optical, electrical, and wetting properties over a long period of time, including after durability testing, while also being fabricated in a way that is industrially scalable. In some aspects, because the copper-, silver-, and/or gold-containing structures may be in the form of discontinuous islands, a dielectric layer formed thereon is in contact with both the discontinuous islands as well as the substrate or adhesion layer, thereby securing the discontinuous islands to the antimicrobial article's surface. In some aspects, the surface of the antimicrobial article containing discontinuous islands of copper, silver, and/or gold has a large contact angle and/or an irregular shape such that the discontinuous islands comprising copper, silver, and/or gold are in some areas exposed to the external environment. In this way, in some aspects, the protective dielectric layer generally does not impede contact between microbes/pathogens and the antimicrobial particles (discontinuous islands comprising copper).

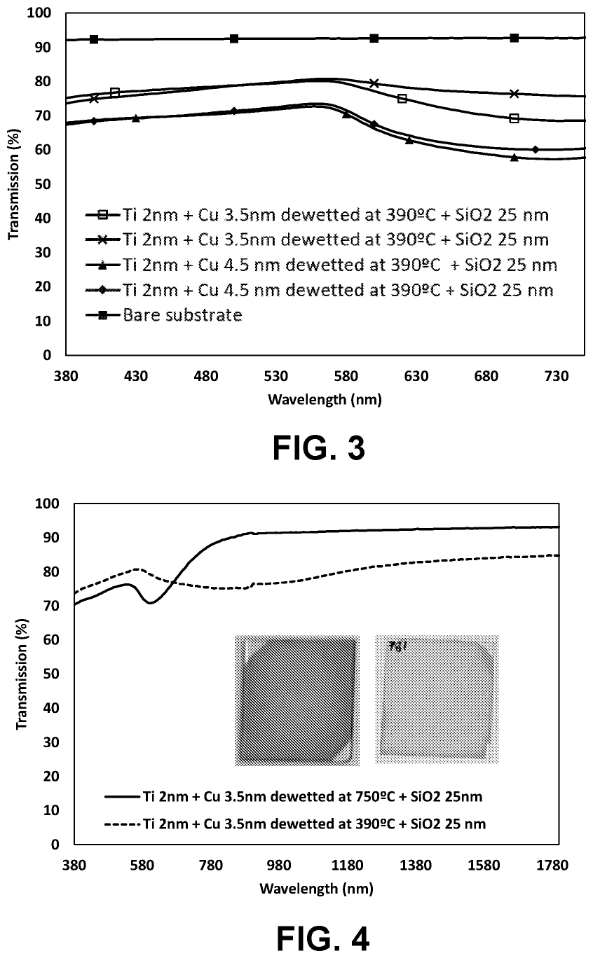

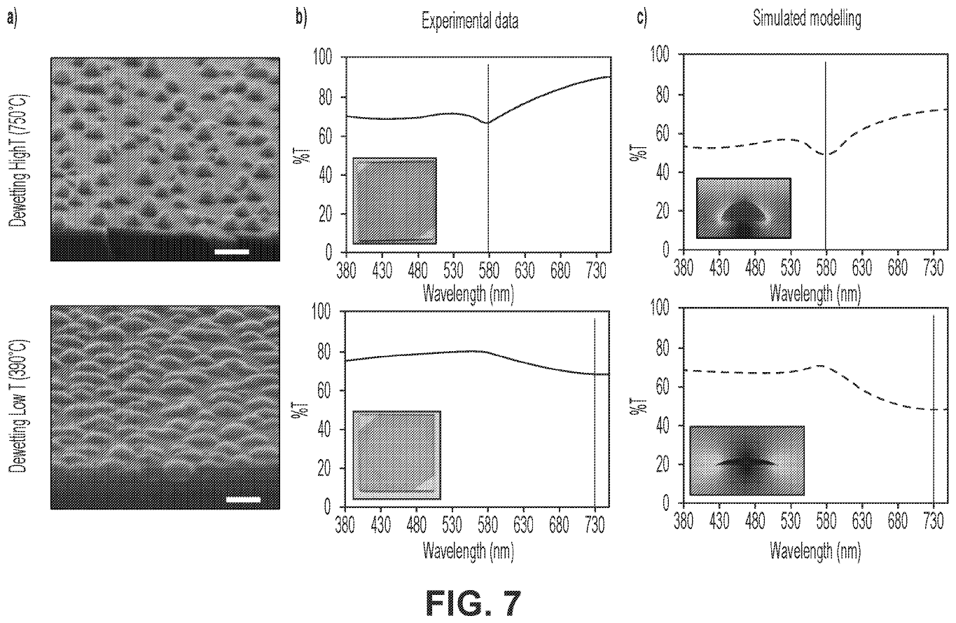

In some aspects, the discontinuous islands have dimensions that are of sufficiently small size and sufficiently large distribution in size such that any plasmonic resonance effect on the coloring of the article is low or at least kept within acceptable values, which generally means the antimicrobial article is characterized by a transparency that does not have a strong dependence on wavelength. For example, as depicted in FIG. 3, FIG. 4, and FIG. 7, the shape, size, and/or size distribution of discontinuous islands has an effect on light transmission as a function of wavelength. In this regard, higher temperature dewetting typically produces discontinuous islands that are more homogeneous in size and with a consistent contact angle >90°, which produces a sharper absorption associated with the stronger plasmonic resonance of the discontinuous islands, as compared to lower temperature conditions. In some aspects, reduction of plasmonic resonance effects also leads to low scattering (i.e., low haze).

In some aspects, the electrically insulating properties of the surface of the antimicrobial article containing discontinuous islands maintains touch-enabled device performance. For example, FIG. 6 shows corresponding finite element predictions over the frequency range required by touch-enabled devices. The touch performance of individual nanocaps is simulated using a Finite Elements Method commercial software (COMSOL Multiphysics®). A 2-D array of nanoparticles was chosen as physical model, considering periodic boundary conditions on the edges of a unit cell. The unit cell is then composed by the substrate, i.e. fused silica, 1-nm thin layer of metallic Ti and a single Cu nanoparticle in air properly shaped. Different profiles of particle geometry, including particle base diameter and contact angle were considered according to the SEM images of the samples to simulate the different touch performance. For the high temperature samples, the nanoparticle shape was made to be more rounded and the nanoparticles density lower while the model for the low temperature samples is composed by flattened nanoparticles and higher density. The low-frequency touch simulation, with corresponding predictions in FIG. 6, was performed using a tetrahedral mesh with minimum size setting that corresponds to the copper radius value. The physical mechanisms of electrical conduction and dielectric polarization were included for the copper, glass, and SiO₂ material regions. Grounded and Applied Voltage electrodes were placed on the top (air-exposed) surface with a width value that matches the lateral conduction length, i.e., generating a square laterally conduction region between the electrodes. The frequency range used in this simulation is 0.1 MHz to 100 MHz with 10 logarithmically-spaced steps.

In some aspects, the optical response of an antimicrobial article can be simulated. The geometry and commercial software employed was the same as described for the touch performance. However, the mesh chosen was a free-triangular mesh that is finer at the boundaries between different materials with the smallest domain equal to 3 nm in the nanoparticle and at the interface between the substrate and air. The metal dielectric function for Cu is taken from McPeak et al. (ACS Photonics 2, 326-333 (2015)), the one for Ti from Johnson and Christy (Phys. Rev. Lett. 6, 4370-4379 (1972)), while for air fixed values of n=1 and k=0 were used and for the substrate n=1.45 and k=0.0001. The frequency range used for the simulation is 4.00×10¹⁴-7.90×10¹⁴ Hz with a step of 8.32×10¹² Hz. The results are shown in FIG. 7, panel (c).

In some aspects, disclosed is an antimicrobial article, comprising:
a substrate comprising a first major surface and a second major surface;
an optional adhesion layer disposed on the first major surface of the substrate;
discontinuous islands comprising copper, silver, gold, or any combination thereof disposed on the first major surface of the substrate, the optional adhesion layer if present, or both; and
a dielectric layer disposed between and at least partially covering the discontinuous islands;
wherein the discontinuous islands and the dielectric layer together form an outer antimicrobial surface.

In some aspects, the antimicrobial articles disclosed herein comprise a substrate. In some aspects, the substrate comprises a first major surface and a second major surface.

In some aspects, the antimicrobial articles disclosed herein comprise an optional adhesion layer disposed on the first major surface of the substrate. In some aspects, the antimicrobial articles disclosed herein comprise an optional adhesion layer on the second major surface. The adhesion layer can be any suitable adhesion layer known in the art to bind copper to a substrate (e.g., a substrate comprising glass). In some aspects, the adhesion layer is or comprises titanium, tantalum, chromium, nickel, or any combination thereof. In some aspects, the adhesion layer is or comprises titanium. In some aspects, the adhesion layer has a thickness (nm) of 1-5, 1-4, 1-3, 1-2, 2-5, 2-4, 2-3, 3-5, 3-4, or 4-5.

In some aspects, the antimicrobial articles disclosed herein comprise discontinuous islands comprising copper, silver, gold, or any combination thereof. In some aspects, the discontinuous islands comprising copper comprise copper(0), copper(I), or a combination thereof. In some aspects, copper(II) may also be present. As used herein, the term “copper” includes copper(0), copper(I), copper(II), or any combination thereof, unless otherwise explicitly specified. In some aspects, the discontinuous islands comprising silver comprise silver(0), silver(I), or a combination thereof. In some aspects, silver (II) may also be present. As used herein, the term “silver” includes silver(0), silver(I), silver(II), or any combination thereof, unless otherwise explicitly specified. In some aspects, the discontinuous islands comprising gold comprise gold(0), gold(I), gold(III), or any combination thereof. As used herein, the term “gold” includes gold(0), gold(I), gold(III), or any combination thereof, unless otherwise explicitly specified. In some aspects, the discontinuous islands comprise copper(0), copper(I), copper(II), silver(0), silver(I), silver(II), gold(0), gold(I), gold(III), or any combination thereof. Each of the aforementioned copper, silver, and gold species can be in any form, such as oxides. In some aspects, the discontinuous islands are disposed on the first major surface, the optional adhesion layer if present, or both. In some aspects, the discontinuous islands are disposed on the second major surface, the optional adhesion layer if present, or both.

In some aspects, a dielectric layer is disposed between and at least partially covering the discontinuous islands.

In some aspects, the discontinuous islands and the dielectric layer together form an outer antimicrobial surface, which may be present on the first major surface, the second major surface, or both.

Referring to FIG. 1, an antimicrobial article 100 is depicted, comprising a substrate 101 and an adhesion layer 102 (optional), discontinuous islands 103 disposed on the adhesion layer 102, and a dielectric layer 104. The discontinuous islands 103 and the dielectric layer 104 together form an outer antimicrobial surface. A hydrophobic and/or oleophobic material 105 is disposed on at least a portion of the outer antimicrobial surface. Although not depicted, substrate 101 abuts adhesion layer 102 at the first major surface of the substrate 101. The second major surface, also not depicted, is on the opposite side of substrate 101 (i.e., at the bottom) of antimicrobial article 100. As depicted schematically in FIG. 1, the size and morphology of the discontinuous islands 103 can be quite varied, in some aspects due to the conditions of the dewetting process and/or thickness of the precursor copper, silver, and/or gold film. In some aspects, the discontinuous islands 103 (e.g., more than 50% by number) having a shape similar to the island on the far right (which is similar to FIG. 7, panel a, bottom SEM image for the 390° C. condition). In some aspects, the discontinuous islands 103 have a shape similar to the middle island or the far left island in FIG. 1 (see also FIG. 7, panel a, top SEM image for the 750° C. condition). In some aspects, the discontinuous islands have a combination of the shapes shown in FIG. 1. In some aspects, the discontinuous islands have a flattened hill shape. In some aspects, the discontinuous islands do not have a spherical shape.

In some aspects, the antimicrobial articles disclosed herein comprise discontinuous islands disposed on both a first major surface and a second major surface, along with a dielectric layer disposed between and at least partially covering the discontinuous islands on one or both of the first and second major surfaces, thereby forming two outer antimicrobial surfaces.

In some aspects, an adhesion layer is present on the antimicrobial article between the substrate and the discontinuous islands. In some aspects, more than one adhesion layer is present. Any suitable adhesion layer (including more than one adhesion layer, such as two or three adhesion layers) can be employed that is sufficient to facilitate adhesion of the discontinuous islands to the substrate. In some aspects, the antimicrobial article does not include an adhesion layer, such that the discontinuous islands are in direct contact with the substrate.

In some aspects, the discontinuous islands comprise copper. In some aspects, the discontinuous islands comprise copper(0) metal, copper(I) oxide, cuprite, copper(II) oxide, or any combination thereof. In some aspects, the discontinuous islands comprise copper(0) metal. In some aspects, the discontinuous islands comprise copper(I) oxide. In some aspects, the discontinuous islands comprise cuprite. In some aspects, the discontinuous islands comprise copper(II) oxide. In some aspects, the discontinuous islands comprise copper(0) metal and copper(I) oxide. In some aspects, the discontinuous islands comprise copper ions, such as copper(I) ions (i.e., Cu¹⁺ ions), copper(II) ions (i.e., Cu²⁺ ions), or a combination thereof. Copper(I) is one of the most antimicrobially efficacious forms of copper, though copper(0) metal also has advantageous AM efficacy. Copper(II) is less effective as an AM agent.

In some aspects, the discontinuous islands comprise silver. In some aspects, the discontinuous islands comprise silver(0) metal, silver(I) oxide, silver(II) oxide, or any combination thereof.

In some aspects, the discontinuous islands comprise gold. In some aspects, the discontinuous islands comprise gold(0) metal, gold(I) oxide, gold(III) oxide, or any combination thereof.

In some aspects, the discontinuous islands have an average height of 20-100 nm, as measured from the first major surface or the optional adhesion layer if present. In some aspects, the discontinuous islands have an average longest lateral dimension of 30-200 nm. In some aspects, the discontinuous islands have an average height of 20-100 nm and an average longest lateral dimension of 30-200 nm, wherein the average height is measured from the first major surface or the optional adhesion layer if present. In some aspects, the average height (nm), as measured from the first major surface or the optional adhesion layer if present, is 20-100, 20-90, 20-80, 20-70, 20-60, 20-50, 20-40, 20-30, 30-100, 30-90, 30-80, 30-70, 30-60, 30-50, 30-40, 40-100, 40-90, 40-80, 40-70, 40-60, 40-50, 50-100, 50-90, 50-80, 50-70, 50-60, 60-100, 60-90, 60-80, 60-70, 70-100, 70-90, 70-80, 80-100, 80-90, or 90-100. In some aspects, the average longest lateral dimension (nm) is 30-200, 30-190, 30-180, 30-170, 30-160, 30-150, 30-140, 30-130, 30-120, 30-110, 30-100, 30-90, 30-80, 30-70, 30-60, 30-50, 30-40, 40-200, 40-190, 40-180, 40-170, 40-160, 40-150, 40-140, 40-130, 40-120, 40-110, 40-100, 40-90, 40-80, 40-70, 40-60, 40-50, 50-200, 50-190, 50-180, 50-170, 50-160, 50-150, 50-140, 50-130, 50-120, 50-110, 50-100, 50-90, 50-80, 50-70, 50-60, 60-200, 60-190, 60-180, 60-170, 60-160, 60-150, 60-140, 60-130, 60-120, 60-110, 60-100, 60-90, 60-80, 60-70, 70-200, 70-190, 70-180, 70-170, 70-160, 70-150, 70-140, 70-130, 70-120, 70-110, 70-100, 70-90, 70-80, 80-200, 80-190, 80-180, 80-170, 80-160, 80-150, 80-140, 80-130, 80-120, 80-110, 80-100, 80-90, 90-200, 90-190, 90-180, 90-170, 90-160, 90-150, 90-140, 90-130, 90-120, 90-110, 90-100, 100-200, 100-190, 100-180, 100-170, 100-160, 100-150, 100-140, 100-130, 100-120, 100-110, 110-200, 110-190, 110-180, 110-170, 110-160, 110-150, 110-140, 110-130, 110-120, 120-200, 120-190, 120-180, 120-170, 120-160, 120-150, 120-140, 120-130, 130-200, 130-190, 130-180, 130-170, 130-160, 130-150, 130-140, 140-200, 140-190, 140-180, 140-170, 140-160, 140-150, 150-200, 150-190, 150-180, 150-170, 150-160, 160-200, 160-190, 160-180, 160-170, 170-200, 170-190, 170-180, 180-200, 180-190, or 190-200. Any average height and any average longest lateral dimension disclosed herein can be combined. In some aspects, any of the foregoing ranges can be combined, such as to provide a range of 80-130 or 190-200, so as to exclude the range of greater than 130 to less than 190.

In some aspects, the discontinuous islands have a ratio of average height (nm) to longest lateral dimension (nm) of 0.1 to 5, wherein the average height is measured from the first major surface or the optional adhesion layer if present. In some aspects, the ratio average height (nm) to longest lateral dimension (nm) is 0.1-5, 0.1-4.8, 0.1-4.6, 0.1-4.4, 0.1-4.2, 0.1-4, 0.1-3.8, 0.1-3.6, 0.1-3.4, 0.1-3.2, 0.1-3, 0.1-2.8, 0.1-2.6, 0.1-2.4, 0.1-2.2, 0.1-2, 0.1-1.8, 0.1-1.6, 0.1-1.4, 0.1-1.2, 0.1-1, 0.1-0.8, 0.1-0.6, 0.1-0.4, 0.1-0.2, 0.2-5, 0.2-4.8, 0.2-4.6, 0.2-4.4, 0.2-4.2, 0.2-4, 0.2-3.8, 0.2-3.6, 0.2-3.4, 0.2-3.2, 0.2-3, 0.2-2.8, 0.2-2.6, 0.2-2.4, 0.2-2.2, 0.2-2, 0.2-1.8, 0.2-1.6, 0.2-1.4, 0.2-1.2, 0.2-1, 0.2-0.8, 0.2-0.6, 0.2-0.4, 0.4-5, 0.4-4.8, 0.4-4.6, 0.4-4.4, 0.4-4.2, 0.4-4, 0.4-3.8, 0.4-3.6, 0.4-3.4, 0.4-3.2, 0.4-3, 0.4-2.8, 0.4-2.6, 0.4-2.4, 0.4-2, 0.4-1.8, 0.4-1.6, 0.4-1.4, 0.4-1.2, 0.4-1, 0.4-0.8, 0.4-0.6, 0.6-5, 0.6-4.8, 0.6-4.6, 0.6-4.4, 0.6-4.2, 0.6-4, 0.6-3.8, 0.6-3.6, 0.6-3.4, 0.6-3.2, 0.6-3, 0.6-2.8, 0.6-2.6, 0.6-2.4, 0.6-2.2, 0.6-2, 0.6-1.8, 0.6-1.6, 0.6-1.4, 0.6-1.2, 0.6-1, 0.6-0.8, 0.8-5, 0.8-4.8, 0.8-4.6, 0.8-4.4, 0.8-4.2, 0.8-4, 0.8-3.8, 0.8-3.6, 0.8-3.4, 0.8-3.2, 0.8-3, 0.8-2.8, 0.8-2.6, 0.8-2.4, 0.8-2.2, 0.8-2, 0.8-1.8, 0.8-1.6, 0.8-1.4, 0.8-1.2, 0.8-1, 1-5, 1-4.8, 1-4.6, 1-4.4, 1-4.2, 1-4, 1-3.8, 1-3.6, 1-3.4, 1-3.2, 1-3, 1-2.8, 1-2.6, 1-2.4, 1-2.2, 1-2, 1-1.8, 1-1.6, 1-1.4, 1-1.2, 1.2-5, 1.2-4.8, 1.2-4.6, 1.2-4.4, 1.2-4.2, 1.2-4, 1.2-3.8, 1.2-3.6, 1.2-3.4, 1.2-3.2, 1.2-3, 1.2-2.8, 1.2-2.6, 1.2-2.4, 1.2-2.2, 1.2-2, 1.2-1.8, 1.2-1.6, 1.2-1.4, 1.4-5, 1.4-4.8, 1.4-4.6, 1.4-4.4, 1.4-4.2, 1.4-4, 1.4-3.8, 1.4-3.6, 1.4-3.4, 1.4-3.2, 1.4-3, 1.4-2.8, 1.4-2.6, 1.4-2.4, 1.4-2.2, 1.4-2, 1.4-1.8, 1.4-1.6, 1.6-5, 1.6-4.8, 1.6-4.6, 1.6-4.4, 1.6-4.2, 1.6-4, 1.6-23.8, 1.6-3.6, 1.6-3.4, 1.6-3.2, 1.6-3, 1.6-2.8, 1.6-2.6, 1.6-2.4, 1.6-2.2, 1.6-2, 1.6-1.8, 1.8-5, 1.8-4.8, 1.8-4.6, 1.8-4.4, 1.8-4.2, 1.8-4, 1.8-3.8, 1.8-3.6, 1.8-3.4, 1.8-3.2, 1.8-3, 1.8-2.8, 1.8-2.6, 1.8-2.4, 1.8-2.2, 1.8-2, 2-5, 2-4.8, 2-4.6, 2-4.4, 2-4.2, 2-4, 2-3.8, 2-3.6, 2-3.4, 2-3.2, 2-3, 2-2.8, 2-2.6, 2-2.4, 2-2.2, 2.2-5, 2.2-4.8, 2.2-4.6, 2.2-4.4, 2.2-4.2, 2.2-4, 2.2-3.8, 2.2-3.6, 2.2-3.4, 2.2-3.2, 2.2-3, 2.2-2.8, 2.2-2.6, 2.2-2.4, 2.4-5, 2.4-4.8, 2.4-4.6, 2.4-4.4, 2.4-4.2, 2.4-4, 2.4-3.8, 2.4-3.6, 2.4-3.4, 2.4-3.2, 2.4-3, 2.4-2.8, 2.4-2.6, 2.6-5, 2.6-4.8, 2.6-4.6, 2.6-4.4, 2.6-4.2, 2.6-4, 2.6-3.8, 2.6-3.6, 2.6-3.4, 2.6-3.2, 2.6-3, 2.6-2.8, 2.8-5, 2.8-4.8, 2.8-4.6, 2.8-4.4, 2.8-4.2, 2.8-4, 2.8-3.8, 2.8-3.6, 2.8-3.4, 2.8-3.2, 2.8-3, 3-5, 3-4.8, 3-4.6, 3-4.4, 3-4.2, 3-4, 3-3.8, 3-3.6, 3-3.4, 3-3.2, 3.2-5, 3.2-4.8, 3.2-4.6, 3.2-4.4, 3.2-4.22, 3.2-4, 3.2-3.8, 3.2-3.6, 3.2-3.4, 3.4-5, 3.4-4.8, 3.4-4.6, 3.4-4.4, 3.4-4.2, 3.4-4, 3.4-3.8, 3.4-3.6, 3.6-5, 3.6-4.8, 3.6-4.6, 3.6-4.4, 3.6-4.2, 3.6-4, 3.6-3.8, 3.8-5, 3.8-4.8, 3.8-4.6, 3.8-4.4, 3.8-4.2, 3.8-4, 4-5, 4-4.8, 4-4.6, 4-4.4, 4-4.2, 4.2-5, 4.2-4.8, 4.2-4.6, 4.2-4.4, 4.4-5, 4.4-4.8, 4.4-4.6, 4.6-5, 4.6-4.8, or 4.8-5. In some aspects, any of the foregoing ranges can be combined, such as to provide a range of 3-3.8 or 4-5, so as to exclude the range of greater than 3.8 to less than 4.

In some aspects, the discontinuous islands are separated by an average distance. In some aspects, an average distance between adjacent bases of the discontinuous islands is 10 to 200 nm, wherein the bases are where the discontinuous islands abut the first major surface or the optional adhesion layer if present. In some aspects, average distance (nm) between adjacent bases of the discontinuous islands is 10-200, 10-180, 10-160, 10-140, 10-120, 10-100, 10-80, 10-60, 10-40, 10-20, 20-200, 20-180, 20-160, 20-140, 20-120, 20-100, 20-80, 20-60, 20-40, 40-200, 40-180, 40-160, 40-140, 40-120, 40-100, 40-80, 40-60, 60-200, 60-180, 60-160, 60-140, 60-120, 60-100, 60-80, 80-200, 80-180, 80-160, 80-140, 80-120, 80-100, 100-200, 100-180, 100-60, 100-140, 100-120, 140-200, 140-180, 140-160, or 180-200. In some aspects, any of the foregoing ranges can be combined, such as to provide a range of 10-40 or 80-180, so as to exclude the range of greater than 40 to less than 80.

In some aspects, at least a portion of a substrate or optional adhesion layer if present has an area fraction of discontinuous islands relative to total surface area of the portion. In some aspects, at least a portion of the substrate or optional adhesion layer if present has an area fraction of discontinuous islands relative to total surface area of the portion of at least 0.3. In some aspects, the area fraction is at least 0.4, or at least 0.5, or at least 0.6, or at least 0.7, or at least 0.8, or at least 0.9, or at least 0.95. In some aspects, the area fraction is 0.3-0.95, 0.3-0.9, 0.3-0.8, 0.3-0.7, 0.3-0.6, 0.3-0.5, 0.3-0.4, 0.4-0.95, 0.4-0.9, 0.4-0.8, 0.4-0.7, 0.4-0.6, 0.4-0.5, 0.5-0.95, 0.5-0.9, 0.5-0.8, 0.5-0.7, 0.5-0.6, 0.6-0.95, 0.6-0.9, 0.6-0.8, 0.6-0.7, 0.7-0.95, 0.7-0.9, 0.7-0.8, 0.8-0.95, 0.8-0.9, or 0.9-0.95. In some aspects, any of the foregoing ranges can be combined, such as to provide a range of 0.3-0.6 or 0.7-0.8, so as to exclude the range of greater than 0.6 to less than 0.7.

In some aspects, at least a portion of the discontinuous islands have an irregular shape. In some aspects, at least 50% of the discontinuous islands have an irregular shape, based on total number of discontinuous islands. In some aspects, at least 50%, or at least 60%, or at least 70%, or at least 80%, or at least 90%, or at least 95%, or at least 99%, or about 100% of the discontinuous islands have an irregular shape, based on total number of discontinuous islands. In some aspects, the amount (%) of discontinuous islands that have an irregular shape, based on total number of discontinuous islands, is 50-100, 50-99, 50-95, 50-90, 50-80, 50-70, 50-60, 60-100, 60-99, 60-95, 60-90, 60-80, 60-70, 70-100, 70-99, 70-95, 70-90, 70-80, 80-100, 80-99, 80-95, 80-90, 90-100, 90-99, 90-95, 95-100, 95-99, or 99-100. In some aspects, any of the foregoing ranges can be combined, such as to provide a range of 50-80 or 90-99, so as to exclude the range of greater than 80 to less than 90. The total number of discontinuous islands can be based on counting and characterizing a representative portion of discontinuous islands. In this context, the term “irregular shape” would be understood to mean shapes that are not uniform, such that spheres, cones, and so forth would not be considered “irregular.” A person skilled in the art of characterizing nanoscale structures on surfaces would understand the meaning of “irregular shape.”

In some aspects, the antimicrobial articles disclosed herein comprise a dielectric layer, as described elsewhere herein. In some aspects, controlled deposition of the protective dielectric layer, e.g. SiO₂, to at least partially cover or fully cover the discontinuous islands is an efficient means of both tuning the rate of copper-, silver-, and/or gold-ion release and enhancing the mechanical durability of the coating without compromising overall desired transparency characteristics. Based on the stability of copper, silver, and/or gold, and on the binding interactions between the metal (e.g., copper, silver, and/or gold) and the material of the dielectric layer, the discharge rate of copper, silver, and/or gold can be tuned. The oxidation of copper(0) or copper(I) oxide into copper(II) oxide has a lessening effect on the antimicrobial action of a surface. Such oxidation can be prevented by use of a protective film coating (e.g., a dielectric layer) that is placed on top of the layer containing copper. A similar strategy can apply to silver and/or gold to the extent the silver and/or gold are affected by exposure to air and/or light. However, generally, the coating should be one that will not inhibit the antimicrobial activity of the article. Stated another way, in some aspects, it is advantageous for the dielectric layer to be effective in protecting the surface from oxidation and/or light degradation while maintaining antimicrobial action. This trade-off has sometimes been difficult to achieve in practice, since copper(I) oxide is antimicrobial, but it is not always easy to control the oxidation such that it does not produce copper(II) oxide, which generally has poor antimicrobial property. However, various dielectric layers useful as a protective coatings disclosed herein generally have achieved or are reasonably expected to achieve such a balance and also increase the durability of the antimicrobially active surface of the antimicrobial articles.

In some aspects, the dielectric layer comprises an inorganic oxide, an inorganic nitride, an inorganic carbide, an inorganic boride, or any combination thereof. In some aspects, the choice of dielectric layer material is not particularly limited, provided that the dielectric layer generally secures the discontinuous islands to the underlying substrate or adhesion layer if present. In some aspects, the inorganic oxide comprises silicon dioxide (SiO₂), zinc oxide (ZnO), titanium dioxide (TiO₂), tin oxide (SnO₂), or any combination thereof. In some aspects, the inorganic nitride comprises silicon nitride (Si₃N₄), tin nitride (Sn₃N₄), tantalum nitride (TaN), zinc nitride (Zn₃N₂), or any combination thereof. In some aspects, the inorganic carbide comprises silicon carbide, chromium carbide, tungsten carbide, molybdenum carbide, tantalum carbide, vanadium carbide, niobium carbide, or any combination thereof. In some aspects, the inorganic boride is a boride of one or more metals comprising titanium, vanadium, nickel, tantalum, chromium, molybdenum, tungsten, or any combination thereof (e.g., titanium boride such as titanium diboride, vanadium boride such as vanadium diboride, nickel boride such as dinickel boride or trinickel boride, tantalum boride such as TaB, Ta₅B₆, Ta₃B₄, or TaB₂, chromium boride such as CrB, molybdenum boride, tungsten boride, or any combination thereof). In some aspects, the nitrides, carbides, and borides generally have sufficient content of N, C, and B, respectively, to achieve negligible electrical conductivity, if any.

In some aspects, the dielectric layer covers at least a portion of the discontinuous islands (e.g., at least a portion of the average height of the discontinuous islands), as measured from the first major surface or the optional adhesion layer if present. In some aspects, the dielectric layer covers at least 50% of an average height of the discontinuous islands, as measured from the first major surface or the optional adhesion layer if present. In some aspects, the dielectric layer covers at least 50%, or at least 60%, or at least 70%, or at least 80%, or at least 90%, or at least 95%, or at least 100%, or at least 110%, or at least 120%, or at least 130%, or at least 140%, or at least 150% of an average height of the discontinuous islands. In some aspects, the dielectric layer covers at least X % of an average height of the discontinuous islands, as measured from first major surface or the optional adhesion layer if present, in which X is 5-150, 5-140, 5-130, 5-120, 5-110, 5-100, 5-95, 5-90, 5-80, 5-70, 5-60, 5-50, 5-40, 5-30, 5-20, 5-10, 10-150, 10-140, 10-130, 10-120, 10-110, 10-100, 10-95, 10-90, 10-80, 10-70, 10-60, 10-50, 10-40, 10-30, 10-20, 20-150, 20-140, 20-130, 20-120, 20-110, 20-100, 20-95, 20-90, 20-80, 20-70, 20-60, 20-50, 20-40, 20-30, 30-150, 30-140, 30-130, 30-120, 30-110, 30-100, 30-95, 30-90, 30-80, 30-70, 30-60, 30-50, 30-40, 40-150, 40-140, 40-130, 40-120, 40-110, 40-100, 40-95, 40-90, 40-80, 40-70, 40-60, 40-50, 50-150, 50-140, 50-130, 50-120, 50-110, 50-100, 50-95, 50-90, 50-80, 50-70, 50-60, 60-150, 60-140, 60-130, 60-120, 60-110, 60-100, 60-95, 60-90, 60-80, 60-70, 70-150, 70-140, 70-130, 70-120, 70-110, 70-100, 70-95, 70-90, 70-80, 80-150, 80-140, 80-130, 80-120, 80-110, 80-100, 80-95, 80-90, 90-150, 90-140, 90-130, 90-120, 90-110, 90-100, 90-95, 95-150, 95-140, 95-130, 95-120, 95-110, 95-100, 100-150, 100-140, 100-130, 100-120, 100-110, 110-150, 110-140, 110-130, 110-120, 120-150, 120-140, 120-130, 130-150, 130-140, or 140-150. In some aspects, it may be desirable to have the dielectric completely coat the discontinuous islands, since the copper, silver, and/or gold ions or compounds may still diffuse out of the dielectric layer and provide antimicrobial effects, and such a “thick” dielectric layer will increase the durability of the antimicrobial surface of the antimicrobial article. In some aspects, any of the foregoing ranges can be combined, such as to provide a range of 60-70 or 80-110, so as to exclude the range of greater than 70 to less than 80.

In some aspects, the dielectric layer has an average height of at least 5 nm, as measured from the first major surface or the optional adhesion layer if present. In some aspects, the dielectric layer has an average height (nm) of at least 10, at least 15, at least 20, at least 25, at least 30, at least 35, at least 40, at least 45, or at least 50. In some aspects, the dielectric layer has an average height (nm) of 5-50, 5-45, 5-40, 5-35, 5-30, 5-25, 5-20, 5-15, 5-10, 10-50, 10-45, 10-40, 10-35, 10-30, 10-25, 10-20, 10-15, 15-50, 15-45, 15-40, 15-35, 15-30, 15-25, 15-20, 20-50, 20-45, 20-40, 20-35, 20-30, 20-25, 25-50, 25-45, 25-40, 25-35, 25-30, 30-50, 30-45, 30-40, 30-35, 35-50, 35-45, 35-40, 40-50, 40-45, or 45-50, as measured from the first major surface or the optional adhesion layer if present. In some aspects, any of the foregoing ranges can be combined, such as to provide a range of 10-40 or 45-50, so as to exclude the range of greater than 40 to less than 45.

In some aspects, the antimicrobial article comprises a substrate. In some aspects, the substrate comprises glass. In some aspects, the substrate comprises glass, and the substrate comprising glass optionally comprises a soda lime glass, an alkali aluminosilicate glass, an ion-exchanged glass, an ion-exchangeable glass, a fused silica glass, an alkali aluminoborosilicate glass, a glass-ceramic, an ion-exchanged glass-ceramic, or any combination thereof. In some aspects, the substrate comprises a soda lime glass, an alkali aluminosilicate glass, an ion-exchanged glass, an ion-exchangeable glass, a fused silica glass, an alkali aluminoborosilicate glass, a glass-ceramic, an ion-exchanged glass-ceramic, or any combination thereof.

In some aspects, the substrate can have any suitable thickness. In some aspects, the substrate has a thickness (mm) of 0.1-2, such as 0.1-1.8, 0.1-1.6, 0.1-1.4, 0.1-1.2, 0.1-1, 0.5-2, 0.5-1.5, 1-2, 1-1.9, 1-1.8, 1-1.7, 1-1.6, 1-1.5, 1-1.4, 1-1.3, 1-1.2, 1-1.1, or 1.5-2. In some aspects, the substrate has a thickness (mm) of 0.1-1, 0.1-0.9, 0.1-0.8, 0.1-0.7, 0.1-0.6, 0.1-0.5, 0.1-0.4, 0.1-0.3, 0.1-0.2, 0.2-1, 0.2-0.9, 0.2-0.8, 0.2-0.7, 0.2-0.6, 0.2-0.5, 0.2-0.4, 0.2-0.3, 0.3-1, 0.3-0.9, 0.3-0.8, 0.3-0.7, 0.3-0.6, 0.3-0.5, 0.3-0.4, 0.4-1, 0.4-0.9, 0.4-0.8, 0.4-0.7, 0.4-0.6, 0.4-0.5, 0.5-1, 0.5-0.9, 0.5-0.8, 0.5-0.7, 0.5-0.6, 0.6-1, 0.6-0.9, 0.6-0.8, 0.6-0.7, 0.7-1, 0.7-0.9, 0.7-0.8, 0.8-1, 0.8-0.9, or 0.9-1. In some aspects, any of the foregoing ranges can be combined, such as to provide a range of 0.1-0.6 or 0.8-1, so as to exclude the range of greater than 0.6 to less than 0.8.

In some aspects, the antimicrobial article comprises a hydrophobic and/or oleophobic material (e.g., a coating). In some aspects, the hydrophobic and/or oleophobic material is disposed on at least a portion of an outer antimicrobial surface (e.g., a surface substrate comprising discontinuous islands and a dielectric layer disposed between and at least partially covering the discontinuous islands) of the antimicrobial article. In some aspects, the hydrophobic and/or oleophobic (e.g., organic silane coating) is also termed an Easy-to-Clean (ETC) coating. In some aspects, the hydrophobic and/or oleophobic material comprises a hydrophobic and/or oleophobic silane. In some aspects, being hydrophobic and/or oleophobic, such a coating enhances the ‘cleanability’ of the surface of the antimicrobial article, repelling dirt and preventing smudging from fingerprints. In some aspects, the ETC may also act as a secondary barrier (or blocking layer), slowing the release of copper, silver, and/or gold (since access of water with coating may be reduced) and further improving the durability to prolong the overall longevity of the surface of the antimicrobial article. In some aspects, the antimicrobial articles have a hydrophobic and/or oleophobic coating. In some aspects, such coating can comprise a hydrophobic and/or oleophobic silane. Examples of such a hydrophobic and/or oleophobic coating include, for example, octadecyltriethoxy silane, fluorosilanes, OPTOOL™ UD509 (a perfluoropolyether silane) available from Daikin Chemical, and other similar materials. In some aspects, the hydrophobic and/or oleophobic material can be diluted in a solvent, such as a fluorinated solvent, to facilitate application to a surface while also helping to control density, thickness, and morphology of the coating. In some aspects, the hydrophobic and/or oleophobic coating acts as a barrier for copper, silver, and/or gold ion transport, and, therefore, such transport can be further controlled by controlling the density/thickness of the hydrophobic and/or oleophobic coating. In some aspects, the hydrophobic and/or oleophobic coating can be employed on the antimicrobial surface at an area percentage coverage of greater than 20% (e.g., greater than any of 30%, 40%, 50%, 60%, 70%, 80%, 90%, 95%, 99%, or 100%), relative to the total usable surface area on the relevant surface of an antimicrobial article. In some aspects, the area percent coverage can be used to control copper, silver, and/or gold ion transport. In some aspects, the hydrophobic and/or oleophobic material is patterned. In some aspects, the patterning facilitates achievement of the desired area percent coverage. In some aspects, patterning the hydrophobic and/or oleophobic coating enables the antimicrobial action to persist in open uncoated areas, or in areas where the coating is very thin or the surface is coating-free while at the same time maintaining intended functional performance of the coating. In some aspects, the coating can be relatively thin, having a thickness, in one aspect, in the range of (less than 10 nm, e.g., less than 8 nm, less than 6 nm, or less than 4 nm). In some aspects, controlling density enables the antimicrobial activity of the antimicrobial surface to remain effective. In some aspects, the coating may be obtained by dip, spray, and/or vapor deposition. In some aspects, one spray or multiple spray cycles (e.g., with low concentration of ETC) can be done to build coating layer thickness while keeping low density. Suitable concentrations of ETC are disclosed elsewhere herein.

In some aspects, the hydrophobic and/or oleophobic coating can be employed in any suitable amount. In some aspects, the hydrophobic and/or oleophobic material can be diluted in any suitable fluorinated solvent prior to application to the antimicrobial surface of the antimicrobial article as a coating. In some aspects, the hydrophobic and/or oleophobic material can be diluted to an amount (wt. %) of 0.001-0.2, 0.001-0.18, 0.001-0.16, 0.001-0.14, 0.001-0.12, 0.001-0.1, 0.001-0.08, 0.001-0.06, 0.001-0.04, 0.001-0.02, 0.001-0.018, 0.001-0.016, 0.001-0.014, 0.001-0.012, 0.001-0.01, 0.001-0.008, 0.001-0.006, 0.001-0.004, 0.001-0.002, 0.002-0.2, 0.002-0.18, 0.002-0.16, 0.002-0.14, 0.002-0.12, 0.002-0.1, 0.002-0.08, 0.002-0.06, 0.002-0.04, 0.002-0.02, 0.002-0.018, 0.002-0.016, 0.002-0.014, 0.002-0.012, 0.002-0.01, 0.002-0.008, 0.002-0.006, 0.002-0.004, 0.005-0.2, 0.005-0.18, 0.005-0.16, 0.005-0.14, 0.005-0.12, 0.005-0.1, 0.005-0.08, 0.005-0.06, 0.005-0.04, 0.005-0.02, 0.005-0.0018, 0.005-0.016, 0.005-0.014, 0.005-0.012, 0.005-0.01, 0.005-0.008, 0.01-0.2, 0.01-0.15, 0.01-0.1, 0.01-0.05, 0.05-0.2, 0.05-0.15, 0.05-0.1, 0.1-0.2, 0.1-0.15, 0.005-0.12, 0.008-0.1, 0.01-0.08, 0.02-0.07, or 0.03-0.06, relative to total mass of the hydrophobic and/or oleophobic material and fluorinated solvent.

In some aspects, the hydrophobic and/or oleophobic coating may be obtained in specific regions on the antimicrobial surface of an antimicrobial article by, for example, microcontact printing, using a master, and/or spray coating through a predetermined mask. Typically, the coating is cured after application is required to adhere the silanes to the antimicrobial surface of the antimicrobial article. In some aspects, the hydrophobic and/or oleophobic coating is cured at low temperature in elevated humidity, for example, at room temperature/ambient humidity for 24 h; 60° C. and 90% relative humidity for 1 hour; or at an elevated temperature in ambient humidity for shorter period of time (<60 min). In some aspects, after curing, the article is rinsed in a fluorinated solvent bath for a time of 3-5 minutes to remove any un-reacted but physically adsorbed hydrophobic and/or oleophobic material.

In some aspects, the hydrophobic and/or oleophobic coating imparts a water contact angle (WCA) that is greater than 80° (e.g., greater than any of 82°, 84°, 86°, 88°, 90°, 92°, 94°, or 96°) and varies by less than 10% (e.g., less than 8%, less than 6%, less than 5%, less than 4%, less than 3%, less than 2%, or less than 1%) after a durability test described elsewhere herein.

In some aspects, the antimicrobial articles comprise additional structures. In some aspects, such additional structures comprise titanium oxide (e.g., TiO₂), zinc oxide (e.g., ZnO), tin oxide (e.g., SnO), or any combination thereof. In some aspects, inclusion of such additional structures provides additional antimicrobial activity to the antimicrobial surfaces of antimicrobial articles. For example, such materials can be photocatalytically active and may react with moisture and light to produce antimicrobial reactive oxygen ion species. Such additional structures, therefore, can assist with enhancing antimicrobial activity under conditions where light and/or moisture are encountered during use of the antimicrobial articles or devices containing the antimicrobial articles.

In some aspects, the antimicrobial articles disclosed herein have various properties.

In some aspects, the antimicrobial articles exhibit an average light transmission of at least 60% of incident light in a range of 380-750 nm. In some aspects, the average light transmission is at least 60%, at least 65%, at least 70%, at least 75%, at least 80%, at least 85%, at least 90%, or at least 95%. In some aspects, the average light transmission (%) is 60-95, 60-90, 60-85, 60-80, 60-75, 60-70, 60-65, 65-95, 65-90, 65-85, 65-80, 65-75, 65-70, 70-95, 70-90, 70-85, 70-80, 70-75, 75-95, 75-90, 75-85, 75-80, 80-95, 80-90, 80-85, 85-95, 85-90, or 90-95. Measurement of the average light transmission in the range of 380-750 nm involves measuring light transmission through the antimicrobial article at each wavelength between 380-750 nm and averaging all values based on the number of wavelengths measured.

In some aspects, the antimicrobial articles disclosed herein exhibit, in a range of 380-750 nm, a difference between minimum light transmission and maximum light transmission of 20% or less. In some aspects, the difference between minimum light transmission and maximum light transmission is 20% or less, 15% or less, 10% or less, or 5% or less. The difference is calculated by subtracting the minimum light transmission value from the maximum light transmission value within the wavelength range of 380-750 nm.

In some aspects, the antimicrobial articles disclosed herein exhibit a transmission haze of 5% or less. In some aspects, the transmission haze is 5% or less, 4.5% or less, 4% or less, 3.5% or less, 3% or less, 2.5% or less, 2% or less, 1.5% or less, 1% or less, 0.5% or less, or 0.1% or less.

In some aspects, the outer antimicrobial surface of the antimicrobial articles exhibits a greater than 3 logarithmic reduction (LR) in a concentration of Staphylococcus aureus as measured according to U.S. Environmental Protection Agency (EPA) 2008 Test Method for Efficacy of Cu Alloy Surfaces as a Sanitizer (i.e., the EPA as disclosed elsewhere herein). In some aspects, the outer antimicrobial surface of the antimicrobial articles exhibits a greater than 2 LR, greater than 2.5 LR, greater than 3 LR, greater than 3.5 LR, greater than 4 LR, greater than 4.5 LR, or greater than 5 LR in a concentration of Staphylococcus aureus, as measured according to the EPA Test.

In some aspects, the outer antimicrobial surface of the antimicrobial articles disclosed herein exhibits a water contact angle (WCA) of at least 80 degrees. In some aspects, the WCA is at least 82°, at least 84°, at least 86°, at least 88°, at least 90°, at least 92°, at least 94°, or at least 96°. Such WCAs can refer to the WCAs of the outer antimicrobial surface with or without the hydrophobic and/or oleophobic material present, as can be specified as desired.

In some aspects, the antimicrobial articles exhibit durability when subjected to a durability test (or wipe test) as described elsewhere herein. In some aspects, when a durability test with at least 100 wipe cycles is performed on the outer antimicrobial surface (with or without a hydrophobic and/or oleophobic material disposed thereon), at least one of average light transmission, transmission haze, logarithmic reduction, difference between minimum light transmission and maximum light transmission, and water contact angle is within 20% (e.g., within any of 15%, 10%, 5%, or 1%) of its original value (i.e., prior to the durability test). In some aspects, at least 300 wipe cycles (e.g., at least 500 wipe cycles, at least 730 wipe cycles, or at least 1200 wipe cycles) are performed and at least one the aforementioned properties are within 20% of its original value. The cloth composition, impregnating liquid, or lack of impregnating liquid (i.e., dry) can be any of the choices as described elsewhere herein and one or more of the aforementioned properties are still within 20% of their original values. In some aspects, average light transmission is within 20% of its original value after such wipe cycles. In some aspects, transmission haze is within 20% of its original value after such wipe cycles. In some aspects, logarithmic reduction is within 20% of its original value after such wipe cycles. In some aspects, difference between minimum light transmission and maximum light transmission is within 20% of its original value after such wipe cycles. In some aspects, water contact angle is within 20% of its original value after such wipe cycles.

In some aspects, the average optical transmission value of an antimicrobial article disclosed herein (which is averaged between 380 and 750 nm) is greater than 60%, e.g., greater than 65%, greater than 70%, greater than 75%, greater than 80%, greater than 85%, greater than 90%, or greater than 95%. In some aspects, after the durability test (wipe test), the optical transmission value averaged between 380 and 750 nm has a variation relative to initial value (i.e., prior to the durability test) of less than 20%, e.g., less than 15%, less than 10%, or less than 5%. In some aspects, the transmission haze is lower than 5%, e.g., less than 4%, less than 3%, less than 2%, less than 1%, or less than 0.5% prior to the durability test.

In some aspects, the antimicrobial articles have a surface-lateral electrical impedance ratio of at least 0.5 over a frequency range of 1 MHz to 100 MHz. In some aspects, the surface-lateral electrical impedance ratio of at least 0.5, at least 0.6, at least 0.7, at least 0.8, or at least 0.9 over a frequency range of 1 MHz to 100 MHz.

In some aspects, the antimicrobial articles can be used in any suitable applications. For example, such applications can include any surface where antimicrobial properties would be advantageous. In some aspects, such applications can include any surface where optical transparency and antimicrobial properties would be advantageous. In some aspects, an antimicrobial article can be used in a screen protector, e.g., a mobile device screen protector, e.g., a screen protector for a touch screen, e.g., a screen protector for a mobile device touch screen. In some aspects, the mobile device is a phone or tablet. In some aspects, the touchscreen is an automated teller machine or kiosk. In some aspects, the antimicrobial articles are anti-glare, e.g., the presence of the discontinuous islands on the surface of the substrate or optional adhesion layer if present provides, in some aspects, an anti-glare property.

In some aspects, disclosed is a consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover glass article disposed over the display, wherein at least one of a portion of the housing or the cover glass article comprises any antimicrobial article disclosed herein.

In some aspects, the consumer electronic product comprises a touchscreen, a mobile device, a phone, or a tablet.

In some aspects, disclosed are methods for making the antimicrobial articles disclosed herein. Any of the components described elsewhere herein for the antimicrobial articles or components thereof are equally applicable in the methods described herein unless clearly contradicted by context (e.g., the same substrates, dielectric layers, discontinuous islands, hydrophobic and/or oleophobic material, and so forth, can be employed in the methods).

In some aspects, disclosed is a method for making an antimicrobial article, the method comprising:
providing a substrate comprising a first major surface and a second major surface;
optionally positioning an adhesion layer on the first major surface;
depositing a layer comprising copper on the first major surface of the substrate, the adhesion layer if present, or both;
thermally treating the layer to form discontinuous islands comprising copper, silver, gold, or a combination thereof; and
disposing a dielectric layer between and at least partially covering the discontinuous islands;
wherein the discontinuous islands and the dielectric layer together form an outer antimicrobial surface.

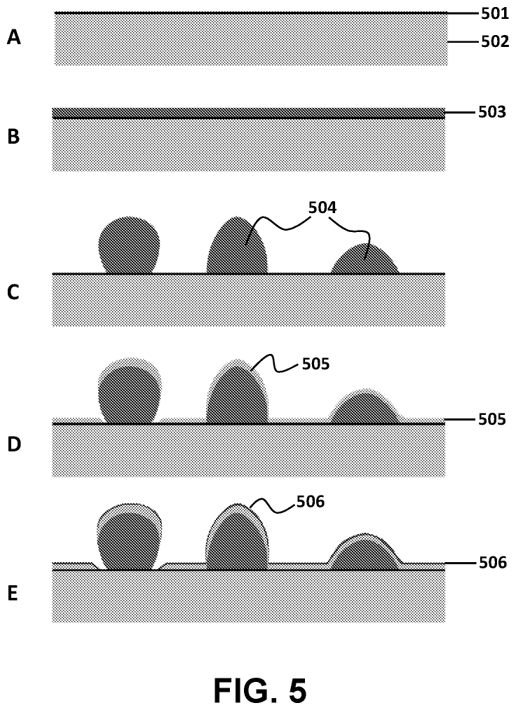

FIG. 5 depicts a schematic representation of a method for preparing antimicrobial articles disclosed herein, including the antimicrobial article of FIG. 1. In FIG. 5, the method comprises: A: providing a substrate 502, optionally depositing an adhesion layer 502 (shown here); B: depositing a film 503 comprising copper onto the adhesion layer 501; C: thermally treating the film 503 to produce a distribution of discontinuous islands 504 on the surface of the adhesion layer 501; D: depositing a dielectric layer 505 between and at least partially covering the discontinuous islands 504; and optionally E: applying a hydrophobic and/or oleophobic material as a coating 506.

In some aspects, the thermally treating step in the methods comprises a temperature at or below a glass transition temperature of the substrate.

In some aspects, the thermally treating step in the methods comprises a temperature (° C.) of 500 or less, e.g., 490 or less, 480 or less, 470 or less, 460 or less, 450 or less, 440 or less, 430 or less, 420 or less, 410 or less, 400 or less, 395 or less, 390 or less, 385 or less, 380 or less, 375 or less, 370 or less, 365 or less, 360 or less, 355 or less, 350 or less, 340 or less, 330 or less, 320 or less, 310 or less, 300 or less, 280 or less, 260 or less, 240 or less, 220 or less, 200 or less, 180 or less, or 160 or less. In some aspects, the thermally treating step in the methods comprises a temperature (° C.) of 150-500, 150-475, 150-450, 150-425, 150-400, 150-390, 150-380, 150-370, 150-360, 150-350, 150-340, 150-330, 150-320, 150-310, 150-300, 150-290, 150-280, 150-270, 150-260, 150-250, 150-240, 150-230, 150-220, 150-210, 150-200, 150-190, 150-180, 150-170, 150-160, 180-500, 180-475, 180-450, 180-425, 180-400, 180-390, 180-380, 180-370, 180-360, 180-350, 180-340, 180-330, 180-320, 180-310, 180-300, 180-280, 180-260, 180-240, 180-220, 180-200, 200-500, 200-475, 200-450, 200-425, 200-400, 200-390, 200-380, 200-370, 200-360, 200-350, 200-340, 200-330, 200-320, 200-310, 200-300, 200-280, 200-260, 200-240, 200-220, 220-500, 220-475, 220-450, 220-425, 220-400, 220-390, 220-380, 220-370, 220-360, 220-350, 220-340, 220-330, 220-320, 220-310, 220-300, 220-280, 220-260, 220-240, 240-500, 240-475, 240-450, 240-425, 240-400, 240-390, 240-380, 240-370, 240-360, 240-350, 240-340, 240-330, 240-320, 240-310, 240-300, 240-280, 240-260, 260-500, 260-475, 260-450, 260-425, 260-400, 260-390, 260-380, 260-370, 260-360, 260-350, 260-340, 260-330, 260-320, 260-310, 260-300, 260-280, 280-500, 280-475, 280-450, 280-425, 280-400, 280-390, 280-380, 280-370, 280-360, 280-350, 280-340, 280-330, 280-320, 280-310, 280-300, 300-500, 300-475, 300-450, 300-425, 300-400, 300-390, 300-380, 300-370, 300-360, 300-350, 300-340, 300-330, 300-320, 300-310, 320-500, 320-475, 320-450, 320-425, 320-400, 320-390, 320-380, 320-370, 320-360, 320-350, 320-340, 320-330, 340-500, 340-475, 340-450, 340-425, 340-400, 340-390, 340-380, 340-370, 340-360, 340-350, 360-500, 360-475, 360-450, 360-425, 360-400, 360-390, 360-380, 360-370, 380-500, 380-475, 380-450, 380-425, 380-400, 380-390, 400-500, 400-475, 400-450, 400-425, 425-500, 425-475, 425-450, 450-500, 450-475, or 475-500. In some aspects, when the substrate comprises an ion-exchanged glass or ion-exchanged glass-ceramic, the temperature is chosen so as to avoid affecting the depth of layer or compressive stress characteristics of the glass or ion-exchanged glass-ceramic.

In some aspects, the thermally treating step in the methods is performed for 1 min to 15 min. In some aspects, the thermally treating step is performed for a time period (min) of 1-15, 1-14, 1-13, 1-12, 1-11, 1-10, 1-9, 1-8, 1-7, 1-6, 1-5, 1-4, 1-3, 1-2, 2-15, 2-14, 2-13, 2-12, 2-11, 2-10, 2-9, 2-8, 2-7, 2-6, 2-5, 2-4, 2-3, 3-15, 3-14, 3-13, 3-12, 3-11, 3-10, 3-9, 3-8, 3-7, 3-6, 3-5, 3-4, 4-15, 4-14, 4-13, 4-12, 4-11, 4-10, 4-9, 4-8, 4-7, 4-6, 4-5, 5-15, 5-14, 5-13, 5-12, 5-11, 5-10, 5-9, 5-8, 5-7, 5-6, 6-15, 6-14, 6-13, 6-12, 6-11, 6-10, 6-9, 6-8, 6-7, 7-15, 7-14, 7-13, 7-12, 7-11, 7-10, 7-9, 7-8, 8-15, 8-14, 8-13, 8-12, 8-11, 8-10, 8-9, 9-15, 9-14, 9-13, 9-12, 9-11, 9-10, 10-15, 10-14, 10-13, 10-12, 10-11, 11-15, 11-14, 11-13, 11-12, 12-15, 12-14, 12-13, 13-15, 13-14, or 14-15.

In some aspects, the thermally treating is performed under a vacuum, an inert atmosphere, or a combination thereof. In some aspects, the vacuum is not perfect (i.e., completely free of any gaseous molecules) but is sufficient to minimize oxidation of the copper, silver, and/or gold in the discontinuous islands, for example, to copper(II) when the discontinuous islands comprise copper, which is the substantially inactive form of copper in terms of AM activity. In some aspects, the inert atmosphere is not perfect (i.e., completely free of any oxidizing gaseous molecules), but is sufficient to minimize oxidation of the copper, silver, and/or gold in the discontinuous islands, for example, to copper(II) when the discontinuous islands comprise copper, which is the substantially inactive form of copper in terms of AM activity.

In some aspects, the layer comprising copper, silver, gold, or any combination thereof that is deposited on the first major surface of the substrate, the adhesion layer if present, or both, has any suitable thickness. For example, the thickness of such layer has a thickness of 2-15 nm. In some aspects, the thickness (nm) of the layer is 2-15, 2-14, 2-13, 2-12, 2-11, 2-10, 2-9, 2-8, 2-7, 2-6, 2-5, 2-4, 2-3, 3-15, 3-14, 3-13, 3-12, 3-11, 3-10, 3-9, 3-8, 3-7, 3-6, 3-5, 3-4, 4-15, 4-14, 4-13, 4-12, 4-11, 4-10, 4-9, 4-8, 4-7, 4-6, 4-5, 5-15, 5-14, 5-13, 5-12, 5-11, 5-10, 5-9, 5-8, 5-7, 5-6, 6-15, 6-14, 6-13, 6-12, 6-11, 6-10, 6-9, 6-8, 6-7, 7-15, 7-14, 7-13, 7-12, 7-11, 7-10, 7-9, 7-8, 8-15, 8-14, 8-13, 8-12, 8-11, 8-10, 8-9, 9-15, 9-14, 9-13, 9-12, 9-11, 9-10, 10-15, 10-14, 10-13, 10-12, 10-11, 11-15, 11-14, 11-13, 11-12, 12-15, 12-14, 12-13, 13-15, 13-14, or 14-15. In some aspects, the film does not need to be completely continuous; there can be some level of noncontinuity or porosity, but some level of continuity is beneficial for forming discontinuous islands having desired size, morphology, and spacing, as disclosed elsewhere herein.

In some aspects, the methods comprise depositing a hydrophobic and/or oleophobic material on at least a portion of the outer antimicrobial surface, wherein the discontinuous islands and the dielectric layer together form an outer antimicrobial surface.

In some aspects, disclosed is a method for making the antimicrobial articles, the method comprising:
providing the substrate comprising the first major surface and the second major surface;
optionally positioning the adhesion layer on the first major surface;
depositing discontinuous islands comprising copper, silver, gold, or any combination thereof on the first major surface of the substrate, the optional adhesion layer if present, or both by way of a Langmuir-Blodgett technique; and
disposing the dielectric layer between and at least partially covering the discontinuous islands;
wherein the discontinuous islands and the dielectric layer together form an outer antimicrobial surface.

The Langmuir-Blodget (LB) technique is well-known in the art. Briefly, nanostructures are added to a trough containing a liquid, generally water, and such nanostructures disperse as a monolayer across the air-liquid interface. A substrate is then passed through the liquid perpendicular to this monolayer, and the nanostructures are transferred to the substrate as a monolayer. In the context of the methods disclosed herein that employ the LB technique, the nanostructures comprise nanoparticles comprising copper (e.g., copper(0) and/or copper(I)), silver (e.g., silver(0), silver(I), and/or silver(II)), gold (e.g., gold(0), gold(I), and/or gold(III)), or any combination thereof, and once deposited onto the substrate would be considered discontinuous islands. Any suitable method known in the art can be used for preparing the copper, silver, and/or gold nanoparticles for use in the LB method. Such particles will disperse as a monolayer in an LB trough, transfer to the substrate as a monolayer, form as discontinuous islands on the substrate, and be at least partially embedded in a dielectric layer (e.g., by disposing the dielectric layer between and at least partially covering the discontinuous islands).

In some aspects, the methods comprise depositing a hydrophobic and/or oleophobic material on at least a portion of the outer antimicrobial surface, wherein the discontinuous islands and the dielectric layer together form an outer antimicrobial surface.

Various aspects are contemplated herein, several of which are set forth in the paragraphs below. It is explicitly contemplated that any aspect or portion thereof can be combined to form a combination.

Aspect 1: An antimicrobial article, comprising:
a substrate comprising a first major surface and a second major surface;
an optional adhesion layer disposed on the first major surface of the substrate;
discontinuous islands comprising copper, silver, gold, or any combination thereof disposed on the first major surface of the substrate, the optional adhesion layer if present, or both; and
a dielectric layer disposed between and at least partially covering the discontinuous islands;
wherein the discontinuous islands and the dielectric layer together form an outer antimicrobial surface.

Aspect 2: The antimicrobial article of any preceding aspect, exhibiting an average light transmission of at least 60% of incident light in a range of 380-750 nm.

Aspect 3: The antimicrobial article of any preceding aspect, wherein, in a range of 380-750 nm, the antimicrobial article exhibits a difference between minimum light transmission and maximum light transmission of 20% or less.

Aspect 4: The antimicrobial article of any preceding aspect, exhibiting a transmission haze of 5% or less.

Aspect 5: The antimicrobial article of any preceding aspect, wherein the outer antimicrobial surface exhibits a greater than 3 logarithmic reduction in a concentration of Staphylococcus aureus as measured according to U.S. Environmental Protection Agency (EPA) 2008 Test Method for Efficacy of Cu Alloy Surfaces as a Sanitizer.

Aspect 6: The antimicrobial article of any preceding aspect, wherein the outer antimicrobial surface exhibits a water contact angle of at least 80 degrees.

Aspect 7: The antimicrobial article of any one of aspects 2-6, or any preceding aspect, wherein, when a durability test with at least 100 wipe cycles is performed on the outer antimicrobial surface, at least one of average light transmission, transmission haze, logarithmic reduction, difference between minimum light transmission and maximum light transmission, and water contact angle is within 20% of its original value.

Aspect 8: The antimicrobial article of any preceding aspect, wherein the antimicrobial article has a surface-lateral electrical impedance ratio of at least 0.5 over a frequency range of 1 MHz to 100 MHz.

Aspect 9: The antimicrobial article of any preceding aspect, wherein the discontinuous islands comprise copper(0), copper(I), or any combination thereof.

Aspect 10: The antimicrobial article of any preceding aspect, wherein the discontinuous islands comprise copper(I) oxide.

Aspect 11: The antimicrobial article of any preceding aspect, wherein the discontinuous islands comprise silver(0), silver(I), silver(II), or any combination thereof.

Aspect 12: The antimicrobial article of any preceding aspect, wherein the discontinuous islands comprise gold(0), gold(I), gold(III), or any combination thereof.

Aspect 13: The antimicrobial article of any preceding aspect, wherein the discontinuous islands have an average height of 20-100 nm and an average longest lateral dimension of 30-200 nm, wherein the average height is measured from the first major surface or the optional adhesion layer if present.

Aspect 14: The antimicrobial article of any preceding aspect, wherein the discontinuous islands have a ratio of average height to longest lateral dimension of 0.1 to 5, wherein the average height is measured from the first major surface or the optional adhesion layer if present.

Aspect 15: The antimicrobial article of any preceding aspect, wherein an average distance between adjacent bases of the discontinuous islands is 10 to 200 nm, wherein the bases are where the discontinuous islands abut the first major surface or the optional adhesion layer if present.

Aspect 16: The antimicrobial article of any preceding aspect, wherein at least a portion of the substrate or optional adhesion layer if present has an area fraction of discontinuous islands relative to total surface area of the portion of at least 0.3.

Aspect 17: The antimicrobial article of any preceding aspect, wherein at least 50% of the discontinuous islands have an irregular shape, based on total number of discontinuous islands.

Aspect 18: The antimicrobial article of any preceding aspect, wherein the dielectric layer comprises an inorganic oxide, an inorganic nitride, an inorganic carbide, an inorganic boride, or any combination thereof.

Aspect 19: The antimicrobial article of any preceding aspect, wherein the dielectric layer covers at least 50% of an average height of the discontinuous islands, as measured from the first major surface or the optional adhesion layer if present.

Aspect 20: The antimicrobial article of any preceding aspect, wherein the dielectric layer has an average height of at least 5 nm, as measured from the first major surface or the optional adhesion layer if present.

Aspect 21: The antimicrobial article of any preceding aspect, wherein the substrate comprises glass, and the substrate comprising glass optionally comprises a soda lime glass, an alkali aluminosilicate glass, an ion-exchanged glass, an ion-exchangeable glass, a fused silica glass, an alkali aluminoborosilicate glass, a glass-ceramic, an ion-exchanged glass-ceramic, or any combination thereof.

Aspect 22: The antimicrobial article of any preceding aspect, further comprising a hydrophobic and/or oleophobic material disposed on at least a portion of the outer antimicrobial surface.

Aspect 23: The antimicrobial article of aspect 22, or any preceding aspect, wherein the hydrophobic and/or oleophobic material comprises a hydrophobic and/or oleophobic silane.

Aspect 24: The antimicrobial article of aspect 22 or 23, or any preceding aspect, wherein the hydrophobic and/or oleophobic material is patterned.

Aspect 25: The antimicrobial article of any preceding aspect, further comprising structures comprising titanium oxide, zinc oxide, tin oxide, or any combination thereof.

Aspect 26: An mobile device screen protector comprising the antimicrobial article of any preceding aspect.

Aspect 27: A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover glass article disposed over the display, wherein at least one of a portion of the housing or the cover glass article comprises the antimicrobial article of any one of aspects 1-25, or any preceding aspect.

Aspect 28: A method for making the antimicrobial article of any one of aspects 1-25, or any preceding aspect, the method comprising:
providing the substrate comprising the first major surface and the second major surface;
optionally positioning the adhesion layer on the first major surface;
depositing a layer comprising copper, silver, gold, or any combination thereof on the first major surface of the substrate, the adhesion layer if present, or both;
thermally treating the layer to form discontinuous islands comprising copper, silver, gold, or any combination thereof; and
disposing the dielectric layer between and at least partially covering the discontinuous islands;
wherein the discontinuous islands and the dielectric layer together form an outer antimicrobial surface.

Aspect 29: The method of aspect 28, or any preceding aspect, wherein the substrate comprises glass, and the substrate comprising glass optionally comprises a soda lime glass, an alkali aluminosilicate glass, an ion-exchanged glass, an ion-exchangeable glass, a fused silica glass, an alkali aluminoborosilicate glass, a glass-ceramic, an ion-exchanged glass-ceramic, or any combination thereof.

Aspect 30: The method of aspect 29, or any preceding aspect, wherein thermally treating comprises a temperature at or below a glass transition temperature of the substrate.

Aspect 31: The method of any one of aspects 28-30, or any preceding aspect, wherein thermally treating comprises a temperature of 400° C. or less.

Aspect 32: The method of any one of aspect 28-31, or any preceding aspect, wherein thermally treating is performed for 1 min to 15 min.

Aspect 33: The method of any one of aspects 28-32, or any preceding aspect, wherein thermally treating is performed under vacuum, an inert atmosphere, or a combination thereof.

Aspect 34: The method of any one of aspects 28-33, or any preceding aspect, wherein the layer comprising copper, silver, gold, or any combination thereof has a thickness of 2-15 nm.

Aspect 35: The method of any one of aspects 28-34, or any preceding aspect, further comprising depositing a hydrophobic and/or oleophobic material on at least a portion of the outer antimicrobial surface.

Aspect 36: The method of any one of aspects 28-35, or any preceding aspect, wherein the discontinuous islands comprise copper(0), copper(I), or any combination thereof.

Aspect 37: The method of any one of aspects 28-36, or any preceding aspect, wherein the discontinuous islands comprise silver(0), silver(I), silver(II), or any combination thereof.

Aspect 38: The method of any one of aspects 28-37, or any preceding aspect, wherein the discontinuous islands comprise gold(0), gold(I), gold(III), or any combination thereof.

Aspect 39: A method for making the antimicrobial article of any one of aspects 1-25, or any preceding aspect, the method comprising:
providing the substrate comprising the first major surface and the second major surface;
optionally positioning the adhesion layer on the first major surface;
depositing discontinuous islands comprising copper, silver, gold, or a combination thereof on the first major surface of the substrate, the optional adhesion layer if present, or both by way of a Langmuir-Blodgett technique; and
disposing the dielectric layer between and at least partially covering the discontinuous islands;
wherein the discontinuous islands and the dielectric layer together form an outer antimicrobial surface.

Aspect 40: The method of aspect 39, or any preceding aspect, further comprising depositing a hydrophobic and/or oleophobic material on at least a portion of the outer antimicrobial surface.

Aspect 41: The method of aspect 39 or 40, or any preceding aspect, wherein the discontinuous islands comprise copper(0), copper(I), or any combination thereof.

Aspect 42: The method of any one of aspects 39-41, or any preceding aspect, wherein the discontinuous islands comprise silver(0), silver(I), silver(II), or any combination thereof.

Aspect 43: The method of any one of aspects 39-42, or any preceding aspect, wherein the discontinuous islands comprise gold(0), gold(I), gold(III), or any combination thereof.

Aspect 44: A combination of any two or more preceding aspects or any portion(s) thereof.

### EXAMPLES

The following examples illustrate non-limiting aspects of the disclosure and are not intended to be limiting on the scope of the disclosure or claims.

### Example 1

Example 1: This example demonstrates the preparation of antimicrobial articles in accordance with some aspects of the disclosure.

Ion-exchanged glass substrates obtained from Corning Incorporated (glass code 2320) having dimensions of 2×2 inches and 0.3 mm thickness were sonicated in organic solvents for 10 minutes and dried with nitrogen gas. As an adhesion layer, a titanium film of 2 nm was deposited onto the glass substrates by DC magnetron sputtering. Immediately after, copper films of 3.5 nm or 4.5 nm in thickness were deposited, also by DC magnetron sputtering, with thickness being controlled by sputtering time. Although copper films are employed in this example, it is contemplated that silver and/or gold can additionally or alternatively be employed. The depositions were performed at a base pressure between about 10⁻⁷ and 10⁻⁸ Torr, room temperature, 100 W of Direct Current (DC) power, and 20 standard cubic centimetres per minute (scc/min) of pure argon (Ar). The working pressure was 1.5×10⁻³ Torr, the extrapolated deposition rate was 0.0454 nm/s for Ti and 0.142 nm/s for Cu, and the target-substrate distance was 35 cm with a rotation speed of 60 rpm. A pre-deposition cleaning of the substrates was performed by exposing the substrates to an Ar plasma (bias power 40 W, pressure 8 mT, Ar flow 20 scc/min) for 5 min. A Ti sputtering target of 99.7% purity was used for seed layer deposition with an DC power of 100 W and a working pressure of 2 mTorr in an argon atmosphere (20 scc/min). Note that generally herein, the tables include the terms “Cu film (nm)” or “Cu (nm),” which is the thickness of a precursor copper film prior to the thermal dewetting process. The copper coated glass articles, which contained a Ti adhesion layer, were then thermally dewetted under vacuum at 390° C. for 15 minutes by a rapid thermal annealing process to form discontinuous islands comprising copper (e.g., copper(0) and/or copper(I)). The dewetting was carried out in the TSUNAMI™ RTP-600S system at the temperature of 390° C., which is below the glass transition temperature of the substrate, for 600 s. High-purity N₂ gas (1 atm pressure) was used to prevent oxidation of the metal film. After dewetting, the glass articles were left to cool in the oven to 25° C. with an N₂ flow of 35 litres per minute. An SEM image of the discontinuous islands comprising copper made from a 3.5 nm copper film is shown in FIG. 2. After cooling, a layer of 10-25 nm of SiO₂, and in some cases up to 50 nm, was deposited conformally onto the discontinuous islands by e-beam evaporation. The deposition was performed at a base pressure between base pressure of about 10⁻⁷ and 10⁻⁸ Torr, room temperature. The SiO₂ e-beam evaporation rate was set to 1 A/s as measured by a quartz microbalance. Thickness tested ranged between 0-50 nm to provide partial coverage the nanoparticles while allowing optimization of the durability and AM efficacy of the AM surface.

Prior to applying a hydrophobic and/or oleophobic material, some antimicrobial glass articles were cleaned with an oxygen plasma of 50 W or 300 W for 1 to 5 minutes. The hydrophobic and/or oleophobic material provides a low surface energy coating, also known as an easy to clean (ETC) coating. Both continuous and patterned ETC coating methods were trialed to obtain the best coating performance. OPTOOL™ UD509 (a perfluoropolyether silane) available from Daikin Chemicals was diluted in NOVEC™ HFE7000 (a hydrofluoroether, which is a fluorinated solvent) available from 3M to 0.005-0.12% by weight and deposited onto the substrates by spray-coating using an airbrush. The airbrush was held 1.5-2 inches away from the antimicrobial articles and sprayed for 20 seconds to enable even coverage. The silane was applied using a mask to provide patterning for some samples. The air pressure varied between 20 to 35 psi, and fluid pressure varied between 2-10 psi. Finally, the coated substrates were cured in a desiccator at room temperature for 1 hr or at room temperature for 2 days, or in an oven at 150° C. at ambient humidity for 30 min. The coated glass articles were then rinsed in a fluorinated solvent (NOVEC™ HFE7200) for a time of 3-5 minutes to remove excess silane.

A summary of the antimicrobial articles prepared in Example 1 are shown in Table 1.

TABLE 1

| | | | | | Pressure (psi) | |
|---|---|---|---|---|---|---|
| Sam- | Cu | | | | FP = fluid | |
| ple | film | SiO₂ | Plasma | ETC | Pressure, | ETC |
| # | (nm) | (nm) | clean | wt % | AP = air Pressue | cure |
| 708 | 3.5 | 15 | 300 W 3 | 0.01 | FP = 6, AP = 30 | 150° C. |
| | | | min | | | 30 min |
| 710 | 3.5 | 15 | 300 W 3 | 0.01 | FP = 6, AP = 30 | RT cure |
| | | | min | | | |
| 711 | 3.5 | 15 | 300 W 3 | 0.02 | FP = 6, AP = 30 | RT cure |
| | | | min | | | |
| 716 | 3.5 | 10 | 300 W 3 | 0.01 | FP = 6, AP = 30 | 150° C. |
| | | | min | | | 30 min |
| 718 | 3.5 | 10 | 300 W 3 | 0.01 | FP = 6, AP = 30 | RT cure |
| | | | min | | | |
| 719 | 3.5 | 10 | 300 W 3 | 0.02 | FP = 6, AP = 30 | RT cure |
| | | | min | | | |
| 724 | 3.5 | 0 | 300 W 3 | 0.01 | FP = 6, AP = 30 | 150° C. |
| | | | min | | | 30 min |
| 726 | 3.5 | 0 | 300 W 3 | 0.01 | FP = 6, AP = 30 | RT cure |
| | | | min | | | |
| 727 | 3.5 | 0 | 300 W 3 | 0.02 | FP = 6, AP = 30 | RT cure |
| | | | min | | | |
| 768P | 4.5 | 15 | 50 W 3 | 0.005 | FP = 2 AP-35 | RT cure |
| | | | min | patterned | | |
| 771P | 4.5 | 15 | 50 W 3 | 0.012 | FP = 2 AP-35 | RT cure |
| | | | min | patterned | | |
| 778P | 3.5 | 15 | 50 W 3 | 0.005 | FP = 2 AP-35 | RT cure |
| | | | min | patterned | | |
| 782P | 3.5 | 15 | X | 0.012 | FP = 2 AP-35 | RT cure |
| | | | | patterned | | |
| 893 | 3.5 | 25 | 50W 3 | 0.005 | FP = 6, AP = 30 | RT cure |
| | | | min | | | |
| 899 | 3.5 | 15 | X | 0.005 | FP = 6, AP = 30 | RT cure |
| 900 | 3.5 | 15 | X | 0.005 | FP = 6, AP = 30 | RT cure |
| 901 | 3.5 | 15 | X | 0.005 | FP = 6, AP = 30 | RT cure |
| 902 | 3.5 | 15 | X | 0.005 | FP = 6, AP = 30 | RT cure |
| 907 | 4.5 | 25 | X | 0.005 | FP = 6, AP = 30 | RT cure |
| 912 | 4.5 | 15 | X | 0.1 | FP = 6, AP = 35 | RT cure |
| 913 | 4.5 | 15 | X | 0.005 | FP = 6, AP = 30 | RT cure |
| 914 | 4.5 | 15 | X | 0.005 | FP = 6, AP = 30 | RT cure |
| 915 | 4.5 | 15 | X | 0.005 | FP = 6, AP = 30 | RT cure |
| 916 | 4.5 | 15 | X | 0.005 | FP = 6, AP = 30 | RT cure |

### Example 2

Example 2: This example demonstrates the antimicrobial (AM) efficacy of the antimicrobial articles disclosed herein, according to some aspects.

Certain samples from Example 1, or prepared according to the procedure of Example 1, were subject to AM efficacy testing according to the EPA Test, as described elsewhere herein. The AM efficacy was performed using S. Aureus as the inoculating microbe. The results are set forth in Table 2 and Table 3. Table 2 contains samples that did not contain an ETC coating, whereas the samples in Table 3 contained ETC coatings.

TABLE 2

| Sample # | Cu film (nm) | SiO₂ (nm) | Log Kill |
|---|---|---|---|
| 706 | 3.5 | 15 | >4 |
| 714 | 3.5 | 10 | >4 |
| 722 | 3.5 | 0 | >4 |

TABLE 3

| Sample | Cu | SiO₂ | [ETC] | ETC cure | |
|---|---|---|---|---|---|
| # | (nm) | (nm) | (%) | conditions | LogKill |
| 708 | 3.5 | 15 | 0.01 | 150° C. 30 min | >2 |
| 710 | 3.5 | 15 | 0.01 | RT cure | >2.5 |
| 711 | 3.5 | 15 | 0.02 | RT cure | >1 |
| 716 | 3.5 | 10 | 0.01 | 150° C. 30 min | >2 |
| 718 | 3.5 | 10 | 0.01 | RT cure | >2 |
| 719 | 3.5 | 10 | 0.02 | RT cure | >1 |
| 724 | 3.5 | 0 | 0.01 | 150° C. 30 min | >5.5 |
| 726 | 3.5 | 0 | 0.01 | RT cure | >5.5 |
| 727 | 3.5 | 0 | 0.02 | RT cure | >2.5 |
| 768P | 4.5 | 15 | 0.005 patterned | RT cure | >5 |
| 771P | 4.5 | 15 | 0.012 patterned | RT cure | >5 |
| 778P | 3.5 | 15 | 0.005 patterned | RT cure | >5 |
| 782P | 3.5 | 15 | 0.012 patterned | RT cure | >2.5 |
| 893 | 3.5 | 25 | 0.005 | RT cure | >5 |
| 899 | 3.5 | 15 | 0.005 | RT cure | >2 |
| 900 | 3.5 | 15 | 0.005 | RT cure | >2 |
| 901 | 3.5 | 15 | 0.005 | RT cure | >3.5 |
| 902 | 3.5 | 15 | 0.005 | RT cure | >3.5 |
| 907 | 4.5 | 25 | 0.005 | RT cure | >5 |
| 912 | 4.5 | 15 | 0.1 | RT cure | >1.5 |
| 913 | 4.5 | 15 | 0.005 | RT cure | >2 |
| 914 | 4.5 | 15 | 0.005 | RT cure | >1.5 |
| 915 | 4.5 | 15 | 0.005 | RT cure | >3.5 |
| 916 | 4.5 | 15 | 0.005 | RT cure | >3.5 |

### Example 3

Example 3: This example demonstrates leaching of copper ions from the surfaces of the antimicrobial articles disclosed herein, according to some aspects.

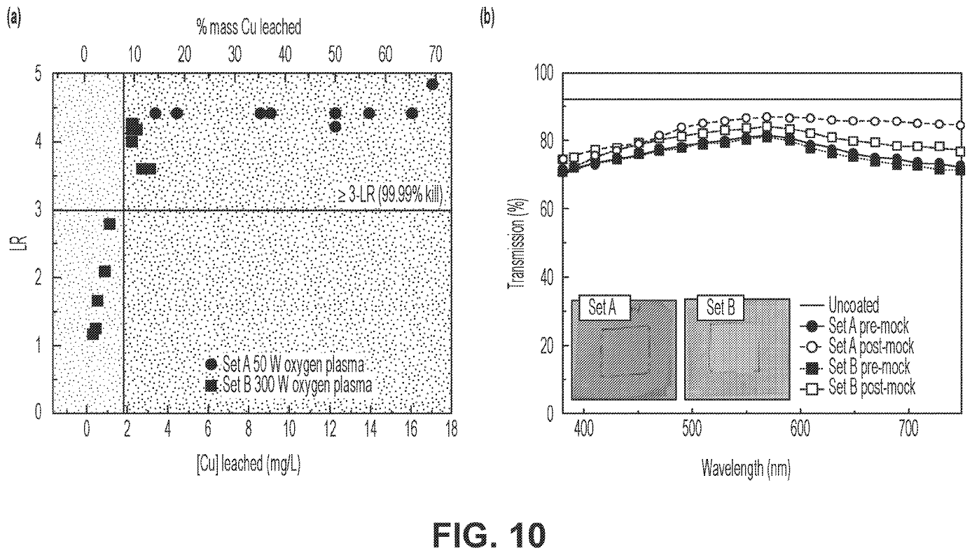

Antimicrobial articles were prepared in the same manner as Example 1 using a 3.5 nm precursor copper film for dewetting. Copper ions from an antimicrobial surface containing discontinuous islands comprising copper equilibrate with those in a liquid medium, including in the aqueous inoculum during the AM test. The amount of copper ions that leach into the liquid medium in the AM test was estimated using a mock test that emulates the same conditions as the AM test. The control and test coupons were treated with the same cleaning and sterilization process as for the EPA Test. The mock test for coper ion content is then performed as follows. Each surface's 1×1 cm² region is incubated with 20 μL suspension of PBS/FBS/TRITON™ X mixture without bacteria. If surface has a hydrophobic or an oleophobic coating and the suspension does not wet properly, nonadsorbing material is added to wet the 20 μL suspension over the 1×1 cm² region. After an incubation period of up to 120 min at 25° C., the 1×1 cm² surface is rinsed with 2×150 μL PBS/FBS/TRITON™ X and the rinse is extracted into a plastic vial for testing using Inductively Coupled Plasma Mass Spectrometry (ICP-MS). Corresponding control experiments were carried out separately with steel metal as a surface and Cu metal as a surface. The copper amount leached, with a unit of mg/L, was converted to the mass and expressed a percent of total mass deposited, considering the fold of dilutions and molar mass for copper. The results are shown in FIG. 10.

Panel (a) of FIG. 10 plots the amount of copper dissolved into the liquid during the mock testing as a function of the LR obtained after the AM testing. All antimicrobial surfaces tested showed evidence of leaching into the PBS droplet with the copper concentration being in the range of 2-20 mg/L. This represents a sensible quantity given that the PBS droplet takes between 20-40 minutes to dry, and it would allow ample time for the metallic copper (0) to be oxidized and dissolved as copper(I) and/or copper(II) ions. The LR correlates positively with the amount copper leached into the media up to −4 mg/L corresponding to a 4-LR in colony counts after which increasing copper dissolution does not statistically affect the LR. We hypothesize that when the antimicrobial surfaces (containing discontinuous islands comprising copper) come into contact with an aqueous solution (e.g. cleaning solvents, moisture, or the PBS solution hosting the bacteria) diffusional equilibrium drives the transport of mobile copper ions to the surface of the coating where the interaction with the microorganism occurs. Once the concentration of free copper ions in solution rises above the threshold tolerated by the microorganism, estimated in panel (a) of FIG. 10 to be around 2 mg/L for a 3-LR, it induces toxic effects. Based on a minimum copper concentration of 2 mg/L, and assuming a uniform distribution of microorganisms in the fluid, we calculated the number of ions, n, available to each microorganism to be in the order of 10¹¹. This is orders of magnitude over the natural intracellular concentration of Cu atoms/ions in S. Aureus, which is reported to be in the region of 10⁴ to 10⁵. Therefore, it is reasonable to assume that the antimicrobial surfaces disclosed herein impose their toxicity by releasing copper in toxic concentrations.

Panel (b) of FIG. 10 shows the optical spectra corresponding to leaching <2 mg/L Cu (squares) and >4 mg/L Cu (circles) during mock testing. Both examples showed an increase in transmission in the region of the plasmonic resonance associated with the discontinuous islands comprising copper. This effect can be explained by reduced plasmonic coupling, as copper dissolved into solution, the discontinuous islands decrease in dimensions, reducing the interactions that give rise to plasmonic coupling.

### Example 4

Example 4: This example demonstrates durability or resistance to general wear-and-tear of the surfaces of the antimicrobial articles disclosed herein, according to some aspects.

Such durability or resistance to wear is determined by a change in optical haze, transmission and/or water contact angle measurements after AM testing, mock testing, and/or abrasion testing.

Antimicrobial articles were prepared in the same manner as Example 1. Table 4 shows that for the selected embodiments, after AM and mock testing, the change in water contact angle of the antimicrobial article surface varies by less than 5% from the initial contact angle value of the coating measured before testing. For other samples, the variation is as low as 3% or less than 1%. The results of the AM or mock testing illustrate good performance of the AM surface in terms of retaining a high water contact angle. “CA” is contact angle; “SDev” is standard deviation; “Cure” means a hydrophobic and/or oleophobic coating has been cured on the surface. Contact angle was measured at five locations and averaged.

TABLE 4

| | Cu | | | CA | | CA after | | |
|---|---|---|---|---|---|---|---|---|
| Sam- | film | SiO₂ | | after | | mock/ | | % |
| ple # | (nm) | (nm) | Test | Cure (°) | SDev | AM (°) | SDev | change |
| 890 | 3.5 | 25 | Mock | 122 | 0 | 119 | 1 | −3% |
| 891 | 3.5 | 25 | AM | 122 | 1 | 124 | 1 | 1% |
| 892 | 3.5 | 25 | Mock | 89 | 2 | 89 | 2 | −1% |
| 893 | 3.5 | 25 | AM | 91 | 3 | 89 | 2 | −2% |
| 904 | 4.5 | 25 | Mock | 123 | 1 | 118 | 1 | −3% |
| 905 | 4.5 | 25 | AM | 124 | 0 | 125 | 0 | 1% |
| 906 | 4.5 | 25 | Mock | 87 | 1 | 83 | 4 | −5% |
| 907 | 4.5 | 25 | AM | 93 | 1 | 91 | 2 | −3% |
| 911 | 4.5 | 15 | Mock | 119 | 0 | 117 | 1 | −2% |
| 912 | 4.5 | 15 | AM | 119 | 0 | 116 | 1 | −2% |

Optical properties of the antimicrobial articles are shown in Table 5. For an optically smooth surface, transmission haze is generally close to zero. For some samples listed in Table 5, the increase in transmission haze after AM and mock testing is less than 40% after 110 wipes, while in others it is less than 30% or less than 20% or less than 10%. In one aspect, the antimicrobial article has a transmission of 80% or more. “H” is transmission haze; “T” is optical transmission. The “as made” samples are prior to adding a hydrophobic and/or oleophobic coating. The “after AM” samples have an AM test performed on the samples having a cured coating.

TABLE 5

| Sam- | Cu | | As | As | After | After | After | After | Change | Change |
|---|---|---|---|---|---|---|---|---|---|---|
| ple | film | Si | made | made | cure | cure | AM | AM | in % | in. % |
| # | (nm) | (nm) | % T | % H | % T | % H | % T | % H | T | H |
| 719 | 3.5 | 10 | 84.2 | 0 | 84.6 | 0.15 | 91.9 | 0.28 | 9 | 28 |
| 893 | 3.5 | 25 | 89.2 | 0.11 | 89.5 | 0.13 | 93.7 | 0.31 | 5 | 18 |
| 902 | 3.5 | 15 | 84 | 0.11 | 84.4 | 0.11 | 93.8 | 0.4 | 12 | 0 |
| 907 | 4.5 | 25 | 86.2 | 0.31 | 92.8 | 0.31 | 93.2 | 0.36 | 8 | 0 |
| 913 | 4.5 | 15 | 80.5 | 0.31 | 80.6 | 0.33 | 92.1 | 0.44 | 14 | 6 |

Optical properties of certain antimicrobial articles are shown in FIG. 3 for the samples shown in Table 6. As shown in FIG. 3, the antimicrobial articles generally have an average transmission between 60-85%.

TABLE 6

| Sample # | Cu film (nm) | SiO₂ (nm) |
|---|---|---|
| 889 | 3.5 | 25 |
| 890 | 3.5 | 25 |
| 903 | 4.5 | 25 |
| 904 | 4.5 | 25 |

The AM surfaces of the AM articles were subjected to a durability test (as described elsewhere herein) with a water wetted cloth, stimulating cleaning activity that is typically carried out using aqueous disinfecting liquids. Each surface was subjected to 330 or 730 wipe cycles with a cloth moistened with DI water and IPA in a 30:70 ratio, where one wipe is defined as two strokes (i.e., one back and forth cycle). Similarly, disposable wipes from LYSOL™ or CLOROX™ were also tested as a wiping material. Transmission and haze were measured using a BYK Haze-Gard iPro. The water contact angle (CA) was measured using a Kruss Goniometer. The results are shown in Table 7. ETC values are in weight percent in a fluorinated solvent.

TABLE 7

| | | | | Transmission & Haze | | | | |
|---|---|---|---|---|---|---|---|---|
| | | | | | | After* | | |
| Sample | Stack | ETC | IPA Wipe | Before* | | | | % change |
| ID | Details** | Coating Details | @ cycles | T % | H | T % | H | in T |
| 899 | Cu 3.5 nm | 0.005% ETC | IPA @330 | 85.5 | 0.13 | 93.8 | 0.17 | 10% |
| | | (double | | | | | | |
| | | spray) | | | | | | |
| 913 | Cu 4.5 nm | 0.005% ETC | IPA @330 | 83.1 | 0.3 | 92.1 | 0.44 | 11% |
| | | (double | | | | | | |
| | | spray) | | | | | | |
| 900 | Cu 3.5 nm | 0.005% ETC | IPA @730 | 87.4 | 0.2 | 92 | 0.4 | 5% |
| | | (double | | | | | | |
| | | spray) | | | | | | |
| 914 | Cu 4.5 nm | 0.005% ETC | IPA @730 | 81.5 | 0.28 | 93.1 | 0.14 | 14% |
| | | (double | | | | | | |
| | | spray) | | | | | | |
| 901 | Cu 3.5 nm | 0.005% ETC | none | 85.7 | 0.08 | | | |
| | | (double | | | | | | |
| | | spray) | | | | | | |
| 915 | Cu 4.5 nm | 0.005% ETC | none | 82.4 | 0.31 | | | |
| | | (double | | | | | | |
| | | spray) | | | | | | |

| | CA (deg) | | | | | |
|---|---|---|---|---|---|---|
| Sample | Before* | | After* | | AM EPA dry test | |
| ID | Mean (deg) | Sigma (deg) | Mean (deg) | Sigma (deg) | log kill | std dev |
| 899 | 112.2 | 0.7 | 107.4 | 1.9 | 2.34 | 0.04 |
| 913 | 111.3 | 1.1 | 107.9 | 1.6 | 2.06 | 0.10 |
| 900 | 112.8 | 0.6 | 108.9 | 0.5 | 2.00 | 0.11 |
| 914 | 110.2 | 1.6 | 108.7 | 1.7 | 1.61 | 0.00 |
| 901 | 110.4 | 0.5 | | | 3.51 | 0.00 |
| 915 | 113.5 | 0.7 | | | 3.51 | 0.00 |

T % = percent transmission
H = haze
* = before or after a durability test that included the IPA wipe cycles indicated
** = all stacks had Ti adhesion layer of 2 nm/Cu precursor film of 3.5 nm or 4.5 nm/15 nm SiO₂ dielectric layer

Table 7 shows that for the selected samples, after a 70% IPA wipe testing, the change in transmission of the AM articles varies only 5-15% from the initial transmission values of the AM articles measured before testing. In addition, contact angle did not show a big decline with wiping. But, samples with lower thicknesses of the silica dielectric layer had AM results for 330 and 730 wipes samples with less than log 3 reduction. Therefore, in some aspects, it may be desirable to increase the thickness of the dielectric layer, such as to 15 nm or thicker.

Samples having 15 nm dielectric layer thickness were prepared in a next round of experiments. Using a patterned ETC approach, two concentrations of ETC at 20-50% fill fraction (coverage) of the surface were tested on 15 nm silica-based embodiments. Table 8 and 9 show abrasion testing with both dry and wet wipes using 100 and 330 cycles respectively for the selected embodiments. Transmission change after dry abrasion was less than 8% for ETC concentrations. Transmission and haze were measured using a BYK Haze-Gard iPro. The water contact angle (CA) was measured using a Kruss Goniometer. ETC values are in weight percent in a fluorinated solvent.

TABLE 8

| | | | | Transmission & Haze | | | | | CA (deg) | | | |
|---|---|---|---|---|---|---|---|---|---|---|---|---|
| | | | Dry Wipe | | | After* | | | Before* | | After* | |
| Sample | Stack | | @ 100 | Before* | | | | change | Mean | Sigma | Mean | Sigma |
| ID | Details** | ETC | cycles | T % | H | T % | H | in T | (deg) | (deg) | (deg) | (deg) |
| 769 | Cu 4.5 nm | 0.005% | yes | 78.8 | 0.24 | 85.4 | 0.49 | 8% | 46.8 | 4.4 | 92 | |
| 773 | Cu 4.5 nm | 0.12% | yes | 78.3 | 0.49 | 80.3 | 0.52 | 3% | 92.0 | 11.5 | 105.13 | |
| 779 | Cu 3.5 nm | 0.005% | yes | 91.6 | 0.13 | 91.8 | 1.3 | 0% | 35.9 | 1.4 | 89.1 | |
| 783 | Cu 3.5 nm | 0.12% | yes | 87.1 | 0.16 | 90.2 | 1.16 | 4% | 73.8 | 8.7 | 102.65 | |

T % = percent transmission
H = haze
* = before or after a durability test that included the wipe cycles indicated
** = all stacks had Ti adhesion layer of 2 nm/Cu precursor film of 3.5 nm or 4.5 nm/15 nm SiO₂ dielectric layer

Table 9 shows selected samples tested with 70% IPA 330 wipe cycles using patterned ETC on surfaces. Transmission change after wet abrasion less than 5% for low and high ETC concentrations for both 3.5 nm and 4.5 nm Cu precursor film thickness and 15 nm silica dielectric layer. After the IPA wipe cycles, samples were tested for antimicrobial efficacy (AM) per the EPA Test and shown to have greater than log 3 reduction. Non-wiped samples with 3.5 nm Cu precursor film and 15 nm silica dielectric layer with high concentration patterned ETC showed lower log kill, but still at an advantageous level of 2.79, compared to the thicker Cu with same silica and ETC. Transmission and haze were measured using a BYK Haze-Gard iPro. The water contact angle (CA) was measured using a Kruss Goniometer. ETC values are in weight percent in a fluorinated solvent.

TABLE 9

| | | | | Transmission & Haze | | | | |
|---|---|---|---|---|---|---|---|---|
| | | | | | | After* | | |
| Sample | Stack | | IPA Wipe | Before* | | | | % change |
| ID | Details** | ETC | @ 330 cycles | T % | H | T % | H | in T |
| 770 | Cu 4.5 nm | 0.005% | yes | 85.12 | 0.23 | 86.73 | 0.24 | 1.88 |
| 780 | Cu 3.5 nm | 0.005% | yes | 89.83 | 0.13 | 91.02 | 0.14 | 1.32 |
| 772 | Cu 4.5 nm | 0.12% | yes | 80.41 | 0.49 | 83.08 | 0.37 | 3.33 |
| 776 | Cu 3.5 nm | 0.12% | yes | 92.10 | 0.14 | 92.42 | 0.18 | 0.35 |
| 775 | Cu 4.5 nm | none | yes | 78.08 | 0.47 | 79.84 | 0.38 | 2.26 |
| 768 | Cu 4.5 nm | 0.005% | no | 80.1 | 0.27 | | | |
| 771 | Cu 4.5 nm | 0.12% | no | 81.5 | 0.27 | | | |
| 778 | Cu 3.5 nm | 0.005% | no | 91.7 | 0.15 | | | |
| 782 | Cu 3.5 nm | 0.12% | no | 86.2 | 0.17 | | | |

| | CA (deg) | | | | | |
|---|---|---|---|---|---|---|
| Sample | Before* | | After* | | AM EPA dry test | |
| ID | Mean (deg) | Sigma (deg) | Mean (deg) | Sigma (deg) | log kill | std dev |
| 770 | 82.92 | 4.54 | 68.93 | 8.82 | 4.96 | 0.00 |
| 780 | 73.43 | 3.46 | 55.09 | 7.63 | 4.96 | 0.00 |
| 772 | 92.23 | 7.16 | 82.59 | 9.33 | 4.96 | 0.00 |
| 776 | 64.68 | 5.07 | 62.23 | 2.30 | 4.96 | 0.00 |
| 775 | 66.98 | 7.00 | 66.69 | 3.78 | 4.96 | 0.00 |
| 768 | 36.9 | 8.4 | | | 5.28 | 0.00 |
| 771 | 77.6 | 22.9 | | | 5.28 | 0.00 |
| 778 | 32.6 | 4.4 | | | 5.28 | 0.00 |
| 782 | 69.3 | 22.7 | | | 2.79 | 0.04 |

T % = percent transmission
H = haze
* = before or after a durability test that included the IPA wipe cycles indicated
** = all stacks had Ti adhesion layer of 2 nm/Cu precursor film of 3.5 nm or 4.5 nm/15 nm SiO₂ dielectric layer

### Example 5

Example 5: This example demonstrates the morphology of the surfaces of some antimicrobial articles disclosed herein, according to some aspects, which have been subjected to two different dewetting conditions. Experimental results are compared with modeled results.

Antimicrobial articles were prepared similarly as in Example 1 using a 3.5 nm precursor copper film for dewetting. The dewetting of the Cu films was performed at low temperature (390° C.) (i.e., sufficiently close to a critical temperature above which dewetting of the continuous film is observed but still below the softening temperature of the substrate, e.g., the glass softening temperature when the substrate comprises glass) to intentionally introduce a degree of inhomogeneity into the contact angle, size, and morphology of the discontinuous islands. Doing so keeps the plasmonic resonance effect on the coloring of the antimicrobial article within acceptable values. Higher temperature dewetting at 750° C. was also performed. Theoretical modeling of the high temperature (750° C.) and low temperature (390° C.) dewetting cases in COMSOL Multiphysics® software program together with a comparison of the simulated and experimental optical spectra provides insight into the advantage of low temperature dewetting for obtaining highly transmissive AM surfaces. This is the same model employed for the lateral-surface impedance predictions. The theoretical model is based on a simplified 2D array of Cu nanoparticles, and thus enables a qualitative rather than quantitative comparison to experimental data. Experimentally, high temperature annealing produced a typical narrowband resonance centered around 580 nm and having a pinkish colour (FIG. 7, panel b). The same process at low temperature produced a broader resonance at longer wavelength and a paler bluish colour (FIG. 7, panel b). The simulated optical spectra (FIG. 7, panel c) are in good agreement to the experimental observations. Without wishing to be bound by theory, it is believed that the broadening and red-shift of the plasmonic resonance in the low temperature annealing case may arise from a combination of two effects: the first may be that low temperature produces flatter particles with a lower contact angle; the second may be that particles are much closer together or in some cases touching (FIG. 7, panel a). The broadening of the resonance gives the coating a transparency without strong dependence on wavelength and the also leads to low scattering (haze)>1%. Thus, the color of the antimicrobial article as a whole remains visually close to the neutral color of the substrate and has a transmission between 70-80% that is substantially independent of wavelength in the visible range. The inset photographs in FIG. 7, panel b (the same photographs as in FIG. 4) demonstrate the visual appearance is such that the functionality of touchscreen devices would be retained. Moreover, as discussed elsewhere herein, modeling for capacitive touch devices was performed for the antimicrobial articles using the Finite Element Model, and such predictions show that the antimicrobial surfaces disclosed herein do not impact the frequency dependence of the surface-lateral electrical impedance in the 1 MHz to 100 MHz frequency range desired by touch-enabled devices, indicating that such AM surfaces would retain touch screen functionality.

### Example 6

Example 6: This example demonstrates the effects of ETC concentration and dielectric layer thickness on AM efficacy and copper loss.

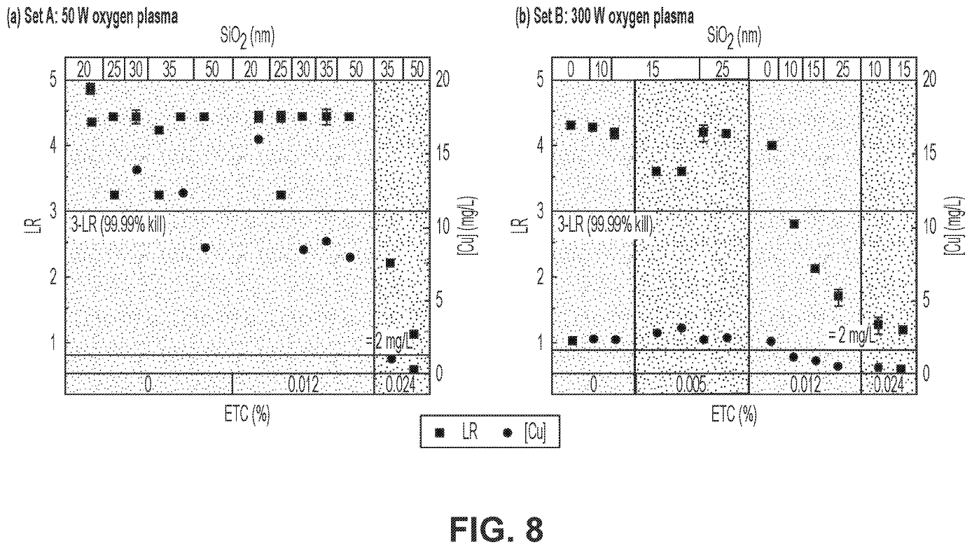

Antimicrobial articles were prepared similarly as in Example 1 using a 3.5 nm precursor copper film for dewetting with varying thicknesses of the dielectric layer (silica) and ETC concentration. The results are presented in FIG. 8, which plots the LR and concentration of copper ([Cu]) leached vs SiO₂ thickness and ETC concentration for surfaces containing discontinuous islands comprising copper treated with (a) 50 W and (b) 300 W oxygen plasma. The differences in [Cu] between Sets A and B was attributed to partial oxidation of the coating with increasing oxygen plasma strength. Set A obtained a greater than 4 LR irrespective of SiO₂ thickness, except with the 0.024% ETC coated samples, where the LR and [Cu] leached generally scaled with SiO₂ thickness concentration. The same trend was observed in Set B, though, the effect of SiO₂ thickness was also observed for the lower (0.012%) ETC concentration. Without wishing to be bound by theory, one possible explanation could be a burst release mechanism in which migration of chloride ions into the discontinuous islands facilitates a fast release of Cu ions such that the effect of the SiO₂ thickness is masked. Then, with the addition of ETC at sufficiently in high concentration, or partial oxidation by high plasma (Set B), migration of chloride is inhibited and the burst release mechanism is prevented and so the additional diffusional control that is imposed by increasing SiO₂ thickness is also be observed.

### Example 7

Example 7: This example demonstrates the durability of the antimicrobial surfaces of the antimicrobial articles in terms of transmission, haze, log reduction (LR) per the EPA Test, and water contact angle (WCA).

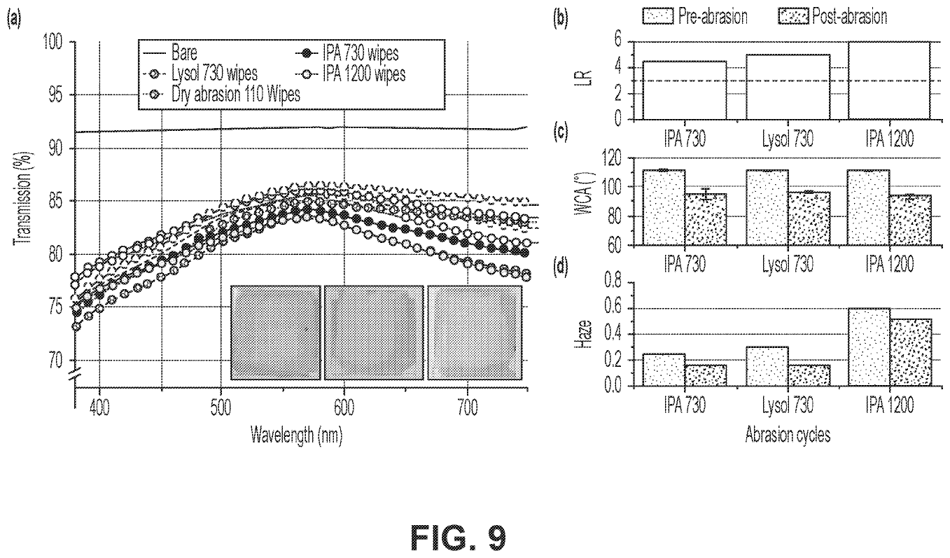

Antimicrobial articles were prepared similarly as in Example 1 using a 3.5 nm precursor copper film for dewetting, a dielectric layer of 25 nm silica, and a ETC coating prepared from 0.012% ETC. Durability tests were conducted as described elsewhere herein using the materials and wipe cycles depicted in FIG. 9.

The results are shown in FIG. 9. As shown in panel (b), the ‘worn’ antimicrobial surfaces exhibited a greater than 99.99% reduction (i.e., greater than log 4 reduction) in S. Aureus colony counts relative to worn control surfaces even after up to 2 years of simulated wear (1200 passes of a IPA impregnated cloth on the coating surface). Furthermore, panels (a), (c), and (d) in FIG. 9 show the transmission, WCA, and haze before and after durability testing. The antimicrobial surfaces maintained their wetting and optical characteristics post abrasion. The samples revealed a less than 5% average gain in transmission and between 10-15% reduction in contact angle with respect to the initial value indicating that the antimicrobial surface containing discontinuous islands comprising copper that are embedded with a dielectric layer are durable. Overall, the results of the abrasion testing suggest an advantageous performance of the antimicrobial surfaces in terms of retaining antimicrobial activity, optical properties, and high-WCA (>90°). In addition, the antimicrobial surfaces are very robust against water and ethanol.

It will be appreciated that the various disclosed aspects or embodiments may involve particular features, elements or steps that are described in connection with that particular aspect or embodiment. It will also be appreciated that a particular feature, element, or step, although described in relation to one particular aspect or embodiment, may be interchanged or combined with alternate aspects or embodiments in various non-illustrated combinations or permutations.

While various features, elements, or steps of particular aspects or embodiments may be disclosed using the transitional phrase “comprising,” it is to be understood that alternative aspects or embodiments, including those that may be described using the transitional phrases “consisting of” or “consisting essentially of,” are implied. Thus, for example, implied alternative aspects or embodiments to a device that comprises A+B+C include aspects or embodiments where a device consists of A+B+C and aspects or embodiments where a device consists essentially of A+B+C.

It will be apparent to those ordinarily skilled in the art that various modifications and variations can be made to the present disclosure without departing from the spirit and scope of the disclosure. Since modifications combinations, sub-combinations, and variations of the disclosed embodiments incorporating the spirit and substance of the disclosure may occur to persons ordinarily skilled in the art, the disclosure should be construed to include everything within the scope of the appended claims and their equivalents.

1. An antimicrobial article, comprising:
a substrate comprising a first major surface and a second major surface;
an optional adhesion layer disposed on the first major surface of the substrate;
discontinuous islands comprising copper, silver, gold, or any combination thereof disposed on the first major surface of the substrate, the optional adhesion layer if present, or both; and
a dielectric layer disposed between and at least partially covering the discontinuous islands;
wherein the discontinuous islands and the dielectric layer together form an outer antimicrobial surface.

2. The antimicrobial article of claim 1, exhibiting at least one of:
an average light transmission of at least 60% of incident light in a range of 380-750 nm;
in a range of 380-750 nm, the antimicrobial article exhibits a difference between minimum light transmission and maximum light transmission of 20% or less;
a transmission haze of 5% or less;
the outer antimicrobial surface exhibits a greater than 3 logarithmic reduction in a concentration of Staphylococcus aureus as measured according to U.S. Environmental Protection Agency (EPA) 2008 Test Method for Efficacy of Cu Alloy Surfaces as a Sanitizer;
the outer antimicrobial surface exhibits a water contact angle of at least 80 degrees;
when a durability test with at least 100 wipe cycles is performed on the outer antimicrobial surface, at least one of average light transmission, transmission haze, logarithmic reduction, difference between minimum light transmission and maximum light transmission, and water contact angle is within 20% of its original value;
the antimicrobial article has a surface-lateral electrical impedance ratio of at least 0.5 over a frequency range of 1 MHz to 100 MHz.

3-8. (canceled)

9. The antimicrobial article of claim 1, wherein the discontinuous islands comprise copper(0), copper(I), or any combination thereof.

10. The antimicrobial article of claim 1, wherein the discontinuous islands comprise copper(I) oxide.

11. The antimicrobial article of claim 1, wherein the discontinuous islands comprise silver(0), silver(I), silver(II), gold(0), gold(I), gold(III), or any combination thereof.

12. (canceled)

13. The antimicrobial article of claim 1, wherein at least one of the following is true:
the discontinuous islands have an average height of 20-100 nm and an average longest lateral dimension of 30-200 nm, wherein the average height is measured from the first major surface or the optional adhesion layer if present;
the discontinuous islands have a ratio of average height to longest lateral dimension of 0.1 to 5, wherein the average height is measured from the first major surface or the optional adhesion layer if present;
an average distance between adjacent bases of the discontinuous islands is 10 to 200 nm, wherein the bases are where the discontinuous islands abut the first major surface or the optional adhesion layer if present;
at least a portion of the substrate or optional adhesion layer if present has an area fraction of discontinuous islands relative to total surface area of the portion of at least 0.3;
at least 50% of the discontinuous islands have an irregular shape, based on total number of discontinuous islands.

14.-17. (canceled)

18. The antimicrobial article of claim 1, wherein the dielectric layer comprises an inorganic oxide, an inorganic nitride, an inorganic carbide, an inorganic boride, or any combination thereof.

19. The antimicrobial article of claim 1, exhibiting at least one of:
the dielectric layer covers at least 50% of an average height of the discontinuous islands, as measured from the first major surface or the optional adhesion layer if present;
the dielectric layer has an average height of at least 5 nm, as measured from the first major surface or the optional adhesion layer if present.

20. (canceled)

21. The antimicrobial article of claim 1, wherein the substrate comprises glass, and the substrate comprising glass optionally comprises a soda lime glass, an alkali aluminosilicate glass, an ion-exchanged glass, an ion-exchangeable glass, a fused silica glass, an alkali aluminoborosilicate glass, a glass-ceramic, an ion-exchanged glass-ceramic, or any combination thereof.

22. The antimicrobial article of claim 1, further comprising a hydrophobic and/or oleophobic material disposed on at least a portion of the outer antimicrobial surface.

23. The antimicrobial article of claim 22, wherein the hydrophobic and/or oleophobic material comprises a hydrophobic and/or oleophobic silane.

24. (canceled)

25. The antimicrobial article of claim 1, further comprising structures comprising titanium oxide, zinc oxide, tin oxide, or any combination thereof.

26. An mobile device screen protector comprising the antimicrobial article of claim 1.

27. A consumer electronic product, comprising:
a housing having a front surface, a back surface and side surfaces;
electrical components provided at least partially within the housing, the electrical components including at least a controller, a memory, and a display, the display being provided at or adjacent the front surface of the housing; and
a cover glass article disposed over the display, wherein at least one of a portion of the housing or the cover glass article comprises the antimicrobial article of claim 1.

28. A method for making the antimicrobial article of claim 1, the method comprising:
providing the substrate comprising the first major surface and the second major surface;
optionally positioning the adhesion layer on the first major surface;
depositing the layer comprising copper, silver, gold, or any combination thereof on the first major surface of the substrate, the adhesion layer if present, or both;
thermally treating the layer to form discontinuous islands comprising copper, silver, gold, or any combination thereof; and
disposing the dielectric layer between and at least partially covering the discontinuous islands;
wherein the discontinuous islands and the dielectric layer together form an outer antimicrobial surface.

29.-30. (canceled)

31. The method of claim 28, wherein at least one of the following is true:
thermally treating comprises a temperature of 400° C. or less;
thermally treating is performed for 1 min to 15 min;
the layer comprising copper, silver, gold, or any combination thereof has a thickness of 2-15 nm.

32.-35. (canceled)

36. The method of claim 28, wherein the discontinuous islands comprise copper(0), copper(I), silver(0), silver(I), silver(II), gold(0), gold(I), gold(III), or any combination thereof.

37.-38. (canceled)

39. A method for making the antimicrobial article of claim 1, the method comprising:
providing the substrate comprising the first major surface and the second major surface;
optionally positioning the adhesion layer on the first major surface;
depositing discontinuous islands comprising copper, silver, gold, or any combination thereof on the first major surface of the substrate, the optional adhesion layer if present, or both by way of a Langmuir-Blodgett technique; and
disposing the dielectric layer between and at least partially covering the discontinuous islands;
wherein the discontinuous islands and the dielectric layer together form an outer antimicrobial surface.

40. (canceled)

41. The method of claim 39, wherein the discontinuous islands comprise copper(0), copper(I), or any combination thereof.

42. The method of claim 39, wherein the discontinuous islands comprise silver(0), silver(I), silver(II), gold(0), gold(I), gold(III), or any combination thereof.

43. (canceled)
